(19) United States
(12) Patent Application Publication
(10) Pub. No.: US 2003/0200296 A1
(43) Pub. Date: Oct. 23, 2003

(54) Apparatus and method for modeling, and storing within a database, services on a telecommunications network

(75) Inventor: Terry P. Lindsey, The Woodlands, TX (US)

Correspondence Address: BAKER BOTTS, LLP, 910 LOUISIANA, HOUSTON, TX, 77002-4995, US

(73) Assignee: Orillion Corporation

(21) Appl. No.: 10/127,315

(22) Filed: Apr. 22, 2002

(51) Int. Cl. G06F 15/173

(52) U.S. Cl. 709/223

(57) ABSTRACT

A method and apparatus for characterizing, organizing, and modeling components of a telecommunications system are presented. The method identifies which components of the system are elements, and which components are behaviors of those elements. The elements and behaviors are further characterized and grouped by like characteristics in a distillation process that generates a set of charts of elements and a set of charts of behaviors. Common characteristics of the charts of elements are discovered and copied to a set of key elements. Similarly, common characteristics of the charts of behaviors are discovered and copied to a set of key behaviors. The characteristics of the system emerge from the characteristics of the key elements and key behaviors. The key behaviors and key elements thus need be the only portions of the database that need be replicated in order to distribute database information about the system as a whole. This replicated core can be distributed to various places within an organization and combined with department-specific information in order to replicate, for all intents and purposes, the entire database. This allows the disparate units within an organization to utilize the complete functionality of the database without requiring a direct link to the database.

### BACKGROUND OF THE INVENTION

1. Field of the Invention

The present invention is related to telecommunications systems. More specifically, the present invention is related to the modeling of telecommunication networks with a digital computer.

2. Description of the Related Technology

Complex networks, and telecommunications networks in particular, can be described in terms of relational databases and object databases. A brief discussion of relation database technology can be found in the “Encyclopedia of Computer Science” Third Edition by Anthony Ralston and Edwin D. Reilly (Van Nostrand Reinhold, New York, 1993) pages 1161-1165. Excerpts from that reference are paraphrased herein for convenience. A relational database is one that is built and operated in accordance with the “relational model of data” proposed by E. F. Codd in his 1970 article entitled “A Relational Model of Data for Large Shared Data Banks,” which may be found in Comm ACM, volume 136, pages 377-387. The Codd model has gained widespread acceptance and has engendered a great deal of additional study covering numerous aspects of database theory and practice.

Primarily, the relational model provides a simple and intuitive method for defining a database, storing and updating data in it, and submitting queries of arbitrary complexity to it. More important, it provides a firm, sound and consistent foundation for all the other topics that database management systems must commonly embrace, such as security and authorization, database integrity, transaction management, recoverability, and distribution of data.

The relational model is founded on the mathematical disciplines of predicate calculus and set theory. All data in a relational database is organized as a set of two-dimensional arrays, or tables. The mathematical term relation occurs in the study of predicate logic but is most commonly used in connection with predicates in exactly two variables. See, for example, E. J. Lemmon, “Beginning Logic” (London: Nelson, 1965). In the relational model, a predicate in any nonnegative number, n, of variables is considered an n-ary relation. For instance, a ternary (3-ary) relation could be “where did who do what.”

An example of a relational table is the common bank check data table, where the verb of the predicates (check written) has become a relation name, and the variables (payor, payee, amount, and date) have become attribute names that are defined in the relational schema of this relation. Normally, there is a set of permissible values for the attribute in question that is part of a domain that underlies the database.

A particular instantiation of a predicate in n variables is represented by an n-tuple. There are other common terms in relational database nomenclature, namely: Table for relation; Heading for relational schema; Column (name) for attribute (name); Row for (n-) tuple; and Body (or extension) for the set of tuples “in” the relation.

There are four important principles in relational database design. First, at each intersection of a row and column, there is exactly one value. This is the principle of first normal form, which is fundamental in the relational model. Second, the order in which the rows are written is unimportant. In other words, the information conveyed, e g, the proposition formed by the predicate and attributes, is the same regardless of the order or rows. Third, the order in which the columns are written is also unimportant. It is only important to know, for each value in a row, to which column that value pertains, and this is normally achieved by writing the value underneath the name (heading) of the column. Finally, writing the same row more than once is redundant as the relational model prohibits duplicate rows.

While data normalization is well established, it is still up to the user to define what the table elements are, what they mean, and what values are placed in the various rows of information. Many prior attempts have been made to model telecommunications systems, and other complex networks. Unfortunately, there is no systematic way to define a network. Lack of a good network definition strategy has led to poor or haphazard component definitions that tend to corrupt or otherwise degrade the utility of the database that contains that information.

When defining a telecommunications network, the concept of traffic must be considered. Traffic is the flow of information or messages throughout the network. Consequently, a definition of a telecommunications network is a system of interconnected elements linked by facilities (e g, physical connections) over which traffic will flow. The traffic may be conversations, information, or complex video or audio services. The telecommunications network must also be able to control the interconnected elements.

In the prior art, databases have been used by network-based companies, in particular, telecommunication companies, for tracking the components and configuration of network systems. These databases are structured to track known configuration information within one type of network. Such databases, however, fail to be able to support the introduction of new technologies into their data structures. For example, a database that organizes and tracks private line circuits cannot support or organize information regarding frame relay or IP technologies. In another example, a database capable of tracking the physical and logical connectivity of a network of digital cross-connect switches cannot easily accommodate the structures necessary for the SONET network over which its inter-machine trunk circuits are carried. Thus, with existing modeling techniques, new databases or complex extensions to existing databases are required to support new communication technologies or application specific information. The end result is a series of disjointed databases with multiple appended tables, all of which cannot be operated, managed, or understood by a single individual. Consequently a large team of people and resources are needed to track the network configuration information and the interdependencies between the network components.

Other prior art network management software system is called “OpenNMS.” OpenNMS is available (for free) via the Internet at http://OpenNMS.org/. As with other prior art systems, OpenNMS utilizes a relational database on a central server with Java clients on distributed systems. However, OpenNMS does not have a rigorous method for identifying elements within the network or identify what their attendant characteristics would be. Moreover, OpenNMS only models a network device as a series of services that are limited to ICMP, SMTP, DNS, HTTP, and FTP. Thus OpenNMS is not generalized for all network systems, and more particularly, OpenNMS is not suitable for telecommunications systems.

Every prior art system within every telecom carrier was designed for a very narrow specific use. Further, the prior art data models were developed in the exact same way with the result that most companies have repeated the prior art data modeling process innumerable times. The result is a collection of many non-compatible data models. Many data models are so radically different that, even though the same information may be required by, and embedded in, multiple data models, variations in the form and organization of that information within the disparate data models makes it extremely difficult to move from one system to another, or to compare the information for consistency from one system to another. The net result is a collection of prior art systems that each operate in a stand-alone fashion, without the benefit of the wealth of information contained in other related systems. he stand-alone nature of each of these many systems creates an environment where data errors are endemic. These kinds of prior art systems require redundant data entry resulting in the creation of entry-errors that are very difficult to find In such an environment, the data inconsistencies across systems grow in the absence of any effective remedial control. Many systems become “stale” because manual data re-entry is too difficult or too expensive to perform consistently on an ongoing basis. The net result is that many prior art systems within the carrier's operations are operating on old data that is no longer consistent with the real world.

Poor simulation models force users to improvise or otherwise make bad assumptions because accurate models could not be built or obtained. As a result, telecommunications companies charged and/or tracked customer usage only to the first switch connection. This prior art practice has several shortcomings. First, it is hard to gauge the effect that the customer's usage is having on overall network performance. Secondly, it is difficult to estimate how much extra bandwidth is available in the network for other customers and how “expensive” that excess bandwidth is. In other words, the prior art methodologies made it difficult to estimate a marketable value for services available from the network.

There is, therefore, a need in the art for a network configuration tracking system that enables one person to identify all of the components of a complex network and to identify the interdependencies within the network. There is also a need in the art for a network modeling system that enables a user to determine what services and capabilities are possible for a given network at a given time.

### SUMMARY OF THE INVENTION

In accordance with the present invention, the disadvantages and problems associated with the inability to model adequately a complex network have been substantially reduced or eliminated. In particular, the present invention provides a systematic and coherent methodology for classifying and organizing both network elements and their behavior, and then developing a database of information that can easily be replicated and distributed. The distributed database can then be used to model specific behavior within the network and to provide overall network system performance.

The data modeling method of the present invention is a method by which data is organized through a series of procedures to separate structural data form intrinsic data in order to facilitate the distribution and replication of meaningful data across enterprise boundaries (both internal and external) in a manner that ensures data integrity. The method of the present invention describes a way of representing, organizing, and identifying the structure that resides in any set of information. If the information so represented and organized has any meaningful structure, it can be represented as a network of information, hereafter referred to as an “information network.”

The present invention is best described as a distillation process, whereby a set of arbitrary information is organized into a set of entities and a set of behaviors that can be further separated into a set of structural information and a set of descriptive information. This organization of the information can then be used as a basis for replicating the more meaningful portions of the information across internal and/or external enterprise boundaries. The method described below explains the sequence of logical steps that comprise the method. The method itself can be outlined in several main steps, namely:

1. Transforming any original information set into subsets of Entities, Proto-Entities, Behaviors, and Proto-Behaviors,

2. Uniquely identifying the Proto-Entities and the Proto-Behaviors;

3. Identifying the Structural Attributes for each Entity and each Behavior,

4. Forming Charts from the Attribute sets; and

5. Mapping the Charts to database tables.

Any arbitrary set of information (the “original information set,” or “I”) can be divided into a set of entity, or proto-entity attributes and a set of behavior, or proto-behavior attributes by the method described herein. The original information set can be separated into two and only two characteristically different groups:

1) the first group, “E,” will be comprised of all possible recognizable sub-sets of I, wherein the information contained within each such sub-set of E pertains to that sub-set and that sub-set only, and a list “LE” exists that comprises all such sub-sets of E, where each element of LE is different from all other elements of LE, although perhaps not uniquely different, which can be otherwise expressed as the equation:

$$E = {⋃}_{j = 1}^{m} {EL}_{i}$$

and

2) the second group, “B,” will be comprised of all possible recognizable sub-sets of I, wherein the information contained within each such sub-set of B pertains to one and only one relationship between two and only two of the elements of LE, and a list “LB” exists that comprises all such sub-sets of B, where each element of LB is different from all other elements of LB, although perhaps not uniquely different, which can be otherwise expressed as the equation:

$$B = {⋃}_{j = 1}^{m} {BL}_{i}$$

and I can be expressed as the equation:

I=E∪B

It should be noted that it is permissible to duplicate any information in I that is required to form E and B, and to form any of the sub-sets contained in the lists, LE, and LB. The information content of each element of LE, shall be referred to herein as “intrinsic” information and the information content of each element of LB, shall be referred to herein as “associative” information.

The total information content of each-and-every element of LE and LB must now be identified, organized, and labeled, and no such information shall be left unidentified, unorganized, and/or unlabeled. The information required for labeling may already be contained within, or it may be arbitrarily added to the information content of, each element of LE and LB. The result of this labeling process is that the contents of each element of LE and LB are now organized into a set of labels and a set of information that corresponds to each such label. Here, a “label” is any first unit of information that is used to uniquely identify a second unit of information. Each label is referred to herein as an “attribute” and the information it identifies is referred to as its “value.” Each attribute thus constructed within each element of LE shall be an “intrinsic” attribute, by definition. Each attribute thus constructed in each element of LB shall be an “associative” attribute, by definition. If possible, the number of elements in LE and LB may be reduced at this stage by eliminating those elements of LE and/or LB that that are aggregations of other elements and are not required to fully contain all of the information in I, subject to the constraints of the process just described.

The remaining elements of LE and LB can now be separated without duplication into those elements that can be uniquely identified and those that cannot be uniquely identified. Those elements of LE that can be uniquely identified are “entities,” by definition, and those elements of LB that can be uniquely identified are “behaviors,” also by definition. Those elements of LE that cannot be uniquely identified are “proto-entities,” by definition, and those elements of LB that cannot be uniquely identified are “proto-behaviors,” also by definition. The set, I, has thus been organized into set of entities, proto-entities, behaviors, and/or proto-behaviors, each consisting of a set of attributes. At this point, the general nature of the method has not reduced the generality of the overall method and has not excluded any elements of the original information set, I.

The next step in the method of the present invention is to transform every proto-entity and every proto-behavior into entities and behaviors, respectively. There are two ways to uniquely identify proto-entities, and/or proto-behaviors. The first is to arbitrarily give a unique identifying attribute to each proto-entity and each proto-behavior. The second is to create a set of attributes—within each such proto-entity and/or proto-behavior—with values that uniquely identify the entity and/or behavior. This is easily accomplished by adding an arbitrary set of attributes to each proto-entity and/or to each proto-behavior in such a manner as to render each such proto-entity and each such proto-behavior unique. Since uniqueness is the only differentiator between entities and proto-entities, and between behaviors and proto-behaviors, all proto-entities, and all proto-behaviors have—by this process—now been transformed into entities and behaviors, respectively.

In a given original set of information, there can be an arbitrarily large number of entities and behaviors. Management of the information in this form may be difficult, or even impossible, due to the potentially large numbers of entities, behaviors, and/or attributes. Therefore, a further step is taken to identify, and then isolate those attributes that are required to establish the uniqueness of each-and-every entity and each-and-every behavior. This process begins by normalizing the attribute set required to establish the uniqueness of each entity and/or behavior. This is accomplished by adding an appropriate minimum set of zero or more attributes—each with a null value—to each entity and each behavior so that all entities have the same set of attributes that establish each entity's uniqueness and all behaviors have the same set of attributes that establish each behavior's uniqueness. Since the values associated with the added attributes are null, each entity and/or behavior suffers no loss of uniqueness, or other detrimental effect on its original set of attributes, by virtue of this process.

A minimum set of attributes—common to every entity—has now been identified by which every entity can be uniquely identified. The same is true for the set of all behaviors. Each such set of common attributes is referred to herein as the “identifying attribute set,” and the element s of such a set are referred to as the identifying attributes. Thus, there is one set of identifying attributes for all entities, and one set of identifying attributes for all behaviors. It should be noted that the set of identifying attributes for all entities is not identical to the set of identifying attributes for all behaviors. A further step is now taken to create a new and separate list of entities where each entity contains only the identifying attributes for each-and-every corresponding original entity. The new set of entities is referred to herein as a “structural representation” of the original entities. In a similar manner, a structural representation of the original behaviors can also be created. Thus, each-and-every entity and each-and-every behavior now has two representations: its structural representation that contains only its identifying attributes and its original representation that contains its entire set of attributes. The original set of entities shall hereafter be referred to as the entity “warehouse representation,” and the original set of behaviors shall be referred to as the behavior “warehouse representation.”

Finally, those entities in the warehouse representation that have only identifying attributes and do not have any other attributes can now be removed from the warehouse representation. The same process can be performed on the behavior warehouse representation. Thus, the structural representation of an entity consists of a set of its identifying attributes, and the warehouse representation of the same entity consists of entity's identifying attributes plus at least one other attribute, or no warehouse representation at all. Similarly, the structural representation of a behavior consists of a set of its identifying attributes, and the warehouse representation of the same behavior consists of the behavior's identifying attributes plus at least one other attribute, or no warehouse representation at all.

The identifying attributes for behaviors, however, must consist of at least two disjoint sub-sets of one or more attributes, where each of the one or more attributes is each identical in name and value to the identifying attributes of each of the two and only two entities to which the behavior refers, plus one behavior-type attribute, plus zero or more attributes as required to establish the uniqueness of each behavior. Not all entities need be referenced by a behavior. Any entity that is not referenced by a behavior is referred to herein as a “disjoint” entity, meaning that it has no logical intersection, or behavior with, the original set of entities. Further, there may be sets of behaviors wherein all behaviors within the set reference a set of entities within a second set, wherein all behaviors outside the set do not reference any entities within the second set. Such sets of entities and behaviors are called disjoint sets because they have no relationship to that information not within their respective sets.

From the structural representation of all entities, a chart can be formed. Each column on such a chart will correspond to one of the entities' identifying attributes and there will be a column on the chart for every identifying attribute contained in each entity. Given this mapping of chart columns to attributes, each-and-every entity in the set is easily mapped into a single row on the chart. When this mapping process is complete, the chart will contain a row for every entity. Thus the entire set of identifying attributes for all entities can be reduced to a single chart where the intersection of every column and row contains the corresponding value of a particular identifying attribute for a particular entity. In exactly the same fashion, a similar chart can be constructed from the structural representation of all behaviors. The charting of warehouse attributes can be carried out in a different manner.

It may be possible to minimize the size of the entity and/or behavior warehouse. If it is desirable to minimize the warehouse, this is accomplished by eliminating all non-identifying attributes having a null value from each-and-every entity's, and/or each-and-every behavior's set of warehouse attributes. The set of warehouse attributes for each entity and/or behavior now includes only those attributes required to fully express the information contained in the original information set and the entity warehouse is therefore minimized. The entity warehouse and the behavior warehouse can now be formed into one or more charts each. This can be done in any manner that results in a set of charts where each chart has at least one column for each identifying attribute. For entity charts, there must be one and only one column corresponding to each of the identifying attributes for entities; for behavior charts, there must be one and only one column corresponding to each identifying attribute for behaviors.

One of many possible methods for forming such warehouse charts is to create groups of entities and/or behaviors, wherein all of the entities and/or behaviors in each such group must have the same set of attributes In the worst case, there will be one group per entity and/or behavior. A chart can now be formed for each of these groups and populated in the same manner as described for the structural representation charts.

The number and nature of the charts formed from each warehouse is arbitrary. Null values are permitted, and redundant attributes and their corresponding values are also permitted in the warehouse charts. Each chart formed as described above can now be mapped directly into a database table. Each chart formed from the structural representations shall be referred to herein as a structural table, and every chart formed from-the warehouse representations shall be referred to as a warehouse table. For any database there can be many non-redundant warehouse tables.

The benefit of following the method of the present invention is that the warehouse tables may be separated into as many physical databases as required for any given application. As long as there is always at least one set of structural tables (one entity table and one behavior table) replicated across all such physical databases, the essential organization of the original information remains intact. Warehouse tables may or may not be replicated, all as required for the intended application. All tables may be partially replicated if the identifying attributes contained in the partially replicated warehouse also appear in the corresponding structural table.

The method described herein will always result in a data structure that is easily adapted to a distributed database environment If the volume of information in the warehouse is substantially larger than the information contained in the structural tables, the problems that will be encountered when distributing such a database of information across a large enterprise, or across a large geographic area, can be minimized.

The method of the present invention is useful for all types of networks. For instance, in situations where more than two Entities all share in a Behavior is easily mapped into the two-Entity form (described above) by establishing a unique Entity that is an Aggregate. Each of the more than two Entities is mapped into the Aggregate Entity via a two-Entity Behavior. Such a multi-Entity Behavior is always expressed as existing between two Entities, an individual Entity, and an Aggregate Entity. In this way, the method of the present invention can be equally effective for scenarios where three or more entities are involved in a single behavior instance.

Other and further objects, features and advantages will be apparent from the following description of presently preferred embodiments of the invention, given for the purpose of disclosure and taken in conjunction with the accompanying drawings.

### BRIEF DESCRIPTION OF THE DRAWINGS

For a more complete understanding of the present invention and its advantages, reference is now made to the following description, taken in conjunction with the accompanying drawings, in which:

FIG. 1a is a block diagram of data concerning a complex network;

FIG. 1b is a block diagram of proto-entities and behavior data according to the method of the present invention;

FIG. 1c is a block diagram of entities and behavior data according to the method of the present invention;

FIG. 1d is a block diagram of entities and proto-behavior according to the method of the present invention;

FIG. 1e is a block diagram of entities and behavior according to the method of the present invention;

FIG. 1f is a block diagram of an entity chart and a behavior chart according to the method of the present invention;

FIG. 1g is a block diagram of entities and behavior according to the method of the present invention;

FIG. 1h is a block diagram of entities and behavior according to the method of the present invention;

FIG. 2 is a flowchart of the abstraction method of the present invention.

FIG. 3a illustrates an entity of the present invention;

FIG. 3b illustrates a set of disconnected Entities of the present invention;

FIG. 3c illustrates an edge of the present invention;

FIG. 3d illustrates an edge connecting two Entities of the present invention;

FIG. 3e illustrates two disconnected sets of Entities linked together by two Behaviors of the present invention;

FIG. 3f illustrates a set of entities of the present invention;

FIG. 3g illustrates a graph of the present invention;

FIG. 3h illustrates a connected containment graph of the present invention;

FIG. 4a illustrates a top view of a connectivity graph of the present invention;

FIG. 4b illustrates a side view of the connectivity graph of FIG. 2a that forms a layer of the present invention;

FIG. 5 illustrates a containment graph that identifies relationships between layers of the present invention;

FIG. 6a illustrates a set of entities having identified hierarchical relationships that form a set of zero or more tree graphs of the present invention;

FIG. 6b illustrates two sets of entities with relationships there-between of the present invention;

FIG. 6c illustrates FIG. 6b within a connectivity graph of the present invention;

FIG. 7 illustrates an unorganized set of network information of the present invention;

FIG. 8 illustrates the separation of the network information of FIG. 7 into two sets of entities of the present invention;

FIG. 9 illustrates the characterization of the network entities of FIG. 7 into classes of the present invention;

FIG. 10 illustrates the classes of FIG. 9 with connectivity relationships identified to form layers of related connectivity graphs of the present invention;

FIG. 11 illustrates the hierarchical relationships of the related connectivity graphs of FIG. 10;

FIG. 12 illustrates containment relationships between the classes of FIG. 11;

FIG. 13 is a block diagram of an example network that will be modeled by the method of the present invention;

FIG. 14 is a block diagram of a service deliver network that will be modeled by the method of the present invention;

FIG. 15 is block diagram of another network circuit that will be modeled by the method of the present invention;

FIG. 16 illustrates a set of information according to the present invention;

FIG. 17 illustrates a set of entities and a set of behaviors within the set of information according to the present invention;

FIG. 18 illustrates elements of the set of entities and the set of behaviors according to the present invention; and

FIG. 19 illustrates the relationships between individual entities and behaviors.

### DETAILED DESCRIPTION OF THE PREFERRED EMBODIMENTS

Definitions

An “Access Span” (or “ASP”) is any Span that Connects to at least one Terminator outside of an SDN and at least one Terminator inside the same SDN. An Access Span is an SDN component.

An “Access Terminator” (or “AT”) is any Terminator that is Connected to at least one ASP. An Access Terminator is an SDN component.

An “Active Physical Element” is any Physical Element that is powered by electricity that is Circuit affecting.

An “Aggregation” is any combination or group of one or more Entities. All Aggregations conform to the definition of an Entity. All Aggregations obey the Rules for Aggregation (see “Rules” below).

“Associative” has the normal meaning for set theory. For example, three elements x, y and z of a set S are said to be associative under a binary operation ‘*’ if they satisfy:

x*(y*z)=(x*y)*z.

An “Asynchronous Circuit” is any Circuit where information is transmitted in bursts and the length, duration, and periodicity of the bursts can vary in time.

An “Asynchronous Network Service” is any Network Service where information is transmitted in bursts and the length, duration, and periodicity of the bursts can vary in time.

An “Attribute” is a parameter, or set of parameters, that has both a name (or identifier) and an associated value.

A “Behavior” is any set of Attributes that 1) references only Behaviors that are described by the set and 2) contains exactly two Attributes that reference different Entities that are not described by the set. The values of the two Entity referencing Attributes, together with the value of at least one other Attribute that is also a member of the same set must uniquely identify the Behavior. A Behavior typically describes one or more functional relationships or as social ions between two Entities. All Behaviors can be represented as Behaviors on a Graph.

A “Behavior Attribute” is any Attribute that pertains to one and only Behavior.

A “Behavior Attribute Set” is any set of Behavior Attributes that all pertain to one and only one Behavior.

A “Cable” is a type of Span that provides a conductive path for conveying electromagnetic (including optical) signals from one point to another. All Cables conform to the definition of an Entity.

A “Cable Aggregation” is any Aggregation of Cables, including Cables-Sets.

A “Cable-Segment” is a Span of uninterrupted Cable having a uniform description and identity (in-so-far-as The present invention is concerned) over its entire length. A Cable-Segment is also a Type of Cable.

A “Cable-Set” is an ordered Aggregation of Cables. The order of Cable Segments within the Aggregation may be coded in any fashion that describes the sequence of Cables that a signal will traverse from one terminal end of the Aggregation to each of the other terminal ends contained within the Aggregation. A Cable-Set is also a Type of Cable.

A “Capacity Attribute” is any one of a possible set of one or more unique Entity Attributes that each expresses an Entity's (each such Entity is called a “Consumed Entity” when referenced to one or more Consuming Entities) quantitative ability to Contain, Connect to, be Consumed by, or Aggregate certain other Entities (each such Entity is called a “Consuming Entity” when referenced to the Consumed Entity). The present invention views such a set of Capacity Attributes as a set of “Consumables.” Every Consuming Entity must be assigned one or more “Entity State Attributes and Values” that can be used to describe the Consumed Entity's State of being Consumed.

A “Carrier Circuit” refers to any Circuit where the information stream associated with the Circuit is subdivided into smaller, lower Capacity, streams (also called “channels,” or “tributaries”).

A “Carrier Network Service” refers to any Network Service where the information stream associated with the Network Service is subdivided into smaller, lower Capacity, streams (also called “channels,” or “tributaries”).

A “Chart” is any two-dimensional array of data sets where. 1) every column of the array corresponds to a single Attribute, 2) every row corresponds to one Entity or Behavior, and 3) each data set element of the array corresponds to the Value (which may be null where appropriate) for the corresponding Attribute and Entity, or Behavior. Every Chart must contain at least one Identifying Attribute with a non-null Value, common to all Entity's or Behavior's represented on the Chart. Alternatively, a Chart may be represented with the columns described above represented as rows, and the rows described above represented as columns without loss of meaning or content. All Charts conform to the definition of an Entity.

A “Circuit” is a Type of Span that describes a channel for the flow of information between two or more points in a Communication Network. All Circuits conform to the definition of an Entity.

A “Circuit Aggregation” is any Aggregation of Circuits, including Circuit-Sets, Circuit-Rings, Redundant-Circuits, and Trunk-Groups.

A “Circuit Hierarchy” refers to any set of Circuits that obey the Rules for Network Service Hierarchies (see Rules, below).

A “Circuit Segment” refers to any Circuit that is not a Circuit Aggregation and is Connected to two or more Logical Ports. A Circuit-Segment is also a Circuit.

A “Circuit Set” is an ordered Aggregation of Circuits. The order of Circuits within the Aggregation may be coded in any fashion that describes the sequence of Circuits that a signal will traverse from one terminal end of the Aggregation to each of the other terminal ends contained within the Aggregation. A Circuit-Set is also a Circuit.

A “Class” describes the common Properties of a set of Entities.

A “Class Structure” exists when all of the Classes, within a set of two or more Classes, are related to all other Classes in the set either by Inheritance, or by Inheriting from a common Super-Class that is also a member of the set.

A “Communication Network” is any set of Terminators and Spans.

A “Communication Network Component” is any subset of the Terminators and/or Spans that together qualify as a Communications Network.

A “Communication Service Capability” is any well-defined method of organizing and/or managing communication signals. A protocol is an example of a Communication Service Capability. All Communication Service Capabilities conform to the definition of an Entity.

A “Communication Service Capability Stack” refers to a Hierarchy of one or more Communication Service Capabilities, where each Communication Service Capability Contains those Communication Service Capabilities that it encapsulates and each Communication Service Capability can directly Contain only one other Communication Service Capability. Any Terminator that terminates, manages, or makes decisions based on an encapsulated Communication Service Capability, must first remove all levels of Communication Service Capabilities that encapsulate the managed Communication Service Capability.

A “Communication Service Inter-Working Capability” refers to the ability of a Physical or Logical Element, or an SDN to translate one Communication Service Capability Stack to another Communication Service Capability Stack for all communication signals that pass through the Physical or Logical Element, or SDN.

A “Component” is any uniquely identified subset of a larger Entity. All Components conform to the definition of an Entity.

“Computed Utilization” is calculated solely and directly from Inventory Attributes using one or more complex algorithms (i.e, more complex than simple summation), or table lookups.

“Connected” is defined as two Entities that are Physically or Logically attached.

A “Connected Graph” is a type of Graph wherein every Graphical Element belonging to the Graph is Graphically Connected to every other Graphical Element belonging to the same Graph.

“Connectivity” is a Type of Peer Behavior wherein two Entities are Connected.

A “Connectivity Graph” is any Graph where all of its points represent Entities and its Behaviors represent Connectivity Behaviors between two Entities. A Connectivity Graph may or may not be Graphically Connected.

“Consumption” refers to the ability of one, or more, Entities to deplete the Capacity of another Entity.

A “Consumption Attribute” is any one of a possible set of one or more unique Entity Attributes that each expresses an Entity's (each called a Consuming Entity when referenced to the Entity they are Consuming, or can Consume) ability to Consume the Capacity of certain other Entities, or Types of Entities (each called a Consumed Entity when referenced to the Consuming Entity).

“Containment” is a Type of Hierarchical Behavior wherein one Entity Contains another Entity.

“Contains” is defined as a first Entity containing a second Entity. If a first Entity, A, “Contains” a second Entity, B, then the first Entity, A, includes within it all of the Entity and Behavior Attributes of the second Entity, B.

A “Core Terminator” (or “CT”) is any Terminator that is Connected to at least one INS and is not Connected to any ASPs. A Core Terminator is an SDN component.

A “Customer” is any Entity that uses a Service-Segment, or to which a Service-Segment has been assigned. All Customers conform to the definition of an Entity.

A process is “Deterministic” if its result or effect can be predicted exactly before it is performed.

A “Direct Subordinate Circuit” is the first Subordinate of one and only one Carrier Network Service.

A “Direct Subordinate Network Service” is the first Subordinate of one and only one Carrier Network Service.

A “Disconnected Graph” or “Disjoint Graph” is defined as a Graph that is not a Connected Graph.

The word “diversity” is a measure of independence between two Entities with respect to a specified criterion With respect to a Communication Network, a first Communications Network Component is Diverse to one or more specific Diversity Domains if, and only if, no Communications Network Components that are described by the Diversity Domain, Aggregate, are Aggregated by, or include the first Communications Network Component. Two or more Communications Network Components are Diverse to one another, with respect to a specific Type Domain, if, and only if, no instance of a Communications Network Component that is Contained within the Type Domain is used in common by the two or more Communications Network Components.

A “Diversity Domain” is a set of one or more Communications Network Components.

A “Dynamically Routed Network” is any communication Network that has the ability to change the Routing of communication traffic as a result of real-time measurements. All Dynamically Routed Networks conform to the definition of an Entity.

An “Element Manager” is a computer system that is used to manage a set of Network Elements.

An “Entity” is a set of Attributes that do not reference any Entity, Behavior, or Attribute that is not an element of the set. The value of at least one Attribute, within an Entity's Attribute set, must uniquely identify the Entity. Every Entity may be represented as a point on a graph. Examples of Entities include: Graphs, Entities, Locations, Pathways, Physical Elements, Cables, Logical Elements, Network Services, Circuits, Service Delivery Networks, Service-Segments, Customers, Access Spans, Intra-Network Spans, Access Terminators, Core Terminators, and the like.

An “Entity Attribute” is any Attribute that is pertains one and only one Entity.

An “Entity Attribute Set” is any set of Entity Attributes that all pertain to one and only one Entity.

An “Externally Managed SDN” is any SDN that relies on commands received from an external system to determine the Routing of its Service Segments.

The word “geographical” refers to occupying a point, line, area, or volume in three-dimensional space.

A “Graph” is a set of zero or more points (alternatively called vertices, or Entities) and zero or more lines (alternatively called Behaviors) each having a finite length (which is not a composition of points), where every edge must terminate on two and only two points.

A “Graphical Aggregation” is any Aggregation of one or more Graphs.

“Graphical Elements” is a general term for both points and Behaviors. Any subset of Graphical Elements, all belonging to the same Graph, also forms a Graph, if such a subset would otherwise qualify as a Graph.

A “Graphical Loop” or “Loop” is defined as any Path where it is possible to start at one point coincident with the Path, then follow the Path and arrive back at the starting point without traversing the same edge more than once.

“Graphically Connected” refers to the situation where two Graphical Elements belonging to the same Graph, and coinciding with a single Path that also belongs to the Graph, are connected.

“Hierarchical Behaviors” include all Behaviors that obey the Rule for Hierarchical Behaviors.

A “Hierarchy” is any set of Entities with Containment Behaviors that can be represented as a Connected Graph and obeys the Rules Governing Hierarchy's:

A “Highest Level Carrier Circuit” (HLCC) is any Circuit Segment that is not a Subordinate of another Carrier Circuit. Typically, an HLCC operates at the transmission rate of the associated Cable.

An “Identifying Attribute” is any aggregation of Entity Attributes, or Behavior Attributes that uniquely identifies, one and only one, Entity, or one and only one, Behavior, respectively. Every Entity and every Behavior must have at least one Identifying Attribute. Every identifying Attribute is also an Attribute of the Entity, or Behavior it identifies. An “Identifying Attribute Set” is a set of Identifying Attributes.

“Inheritance” is defined as the inclusion of Properties from one Class by another Class. If Class A Inherits the Properties of Class B, then Class A is a “Sub-Class” of Class B, and Class B is the “Super-Class” of Class A. All Entities belonging to a single Sub-Class will exhibit all Behaviors and Attributes associated with that Class's Super-Class.

An “INS-Set” refers to any set of two or more INSs that form a Path within an SDN's Connectivity Graph. An INS-Set must not contain any Graphical Loops. An INS-Set is an SDN component.

An “INS Set” refers to any Aggregation of two or more INSs that form a Layer. An INS-Set is an SDN component.

An “Instance” shall mean an occurrence of individual object-specific thing for which a specific proposition or definition holds. In the case of the present invention, an instance is usually either an individual entity or an individual behavior.

An “Internally Managed Network” is any SDN wherein the Element Manager or the Network Elements themselves determine some, or all of the Routing of its Service-Segments, or communication traffic.

An “Intra-Networking Span” (or “INS”) is any Span that Connects to two or more Terminators all belonging to the same SDN. An Intra-Networking Span is an SDN component.

“Intrinsic” is defined as an essential nature or characteristic of the Network to be modeled.

“Inventory” is a detailed list of Physical or Logical assets. Such assets can include, raw materials, works-in-progress, end products, customers, or any item that is of concern to an operation. A Network Inventory is a detail record of all Network Components and how they are combined and configured to provide Services to Customers.

An “Isochronous Circuit” is any Circuit where the information stream 1) does not vary in time, or 2) varies only in bursts having a fixed length, duration, and periodicity.

An “Isochronous Network Service” is any Network Service where the transmission of information 1) does not vary in time, or 2) varies only in bursts having a fixed length, duration, and periodicity.

“Label” is defined as an identifier of the entity, behavior or set of information.

A “Layer” is a single Connected Connectivity Graph.

A “Location” is a type of Terminator that corresponds to a position in three-dimensional space.

“Logical” refers to the characteristic of an Entity's existence being supported by the contents of an electronic memory device. All Logical Entities and their Behaviors can be altered only through the action of an executing computer process (including firmware process).

A “Logical Element” corresponds to a Logical electronic, electrical, or mechanical device, or Logical portion of a device that is a Communications Network Component. Every Logical Element must be Contained by a Physical Element. All Logical Elements conform to the definition of an Entity.

A “Logical Port” is a Logical Element that corresponds to a configurable and/or discernable subset of an electrical or electromagnetic (including optical) signal passing through a given Physical Port. All Logical Ports conform to the definition of an Entity.

A “Loop” is a set of nodes and edges through which one may start at one node and go through one or more other nodes and return to the original node.

“Measured Utilization” refers to any Utilization that must be calculated from one or more real-time, quasi-real-time, or historical performance measurements on a live Communications Network.

A “Network” is any set of Entities together with a set of Behaviors referencing only those Entities. All Networks conform to the definition of an Entity.

A “Network Component” is any Component of a Network.

A “Network Element” is any Terminator found in the Physical Strata of the present invention. A Network Element typically corresponds to an electronic, electrical, or mechanical device, or identifiable portion of a device, that is itself a Communication Network Component.

A “Network Information Model” is a well-organized set of Network Components and Behaviors that is managed by The present invention.

A “Network Service” is a Type of Span that describes a Service-Segment, or a Component of a Service-Segment, of an SDN. All Circuits are Network Services. All Network Services conform to the definition of an Entity.

A “Network Service Hierarchy” refers to any set of Network Services that obey the Rules for Network Service Hierarchies.

A “Network Service-Segment” refers to any Network Service that is not a Network Service Aggregation and is Connected to two or more Logical Ports. A Network Service-Segment is also a Network Service.

A “Network Service-Set” is an ordered Aggregation of Network Services. The order of Network Services within the Aggregation may be coded in any fashion that describes the sequence of Network Services that a signal will traverse from one terminal end of the Aggregation to each of the other terminal ends (if any) contained within the Aggregation. A Network Service-Set is also a Network Service.

A “Non-Null Graph” is a Graph with one or more points.

A “Null Graph” is defined as a Graph with zero points (and, thus, zero Behaviors).

A “Passive” Physical Element is any Physical Element that is not powered by electricity or that is not Circuit affecting.

A “Path” is any series of Behaviors that trace a continuous, unbroken line on a Graph.

A “Pathway” is a type of Span that describes an identifiable Geographical route. Pathways conform to the definition of an Entity.

A “Pathway Aggregation” is any Aggregation of Pathways, including Pathway-Sets.

A “Pathway-Segment” is an uninterrupted Pathway having a uniform description and identification (in-so-far-as The present invention is concerned) over its entire length that Connects two Locations. A Pathway-Segment is also a Pathway.

A “Pathway-Set” is an ordered Aggregation of Pathways. The order of Pathways within the Aggregation may be coded in any fashion that describes the sequence of Pathways that a Cable will traverse from one terminal end of the Aggregation to each of the other terminal ends contained within the Aggregation. A Pathway-Set also a Pathway.

A “Peer Behavior” includes all Behaviors that obey the Rule for Peer Behaviors.

A “Permanent Circuit” is any Circuit that is assumed to have an infinite (or long) lifetime.

A “Permanent Network Service” is any Network Service that is assumed to have an infinite (or long) lifetime.

“Physical” means having a material existence.

A “Physical Element” is a type of Terminator that corresponds to an electronic, electrical, or mechanical device, or identifiable portion of a device, that is a Component of a Communications Network and is Contained by a Location. All Physical Elements conform to the definition of an Entity.

A “Physical Port” is a Physical Element that 1) can be Connected to a Cable, and 2) is Contained by another Physical Element.

A “Primary Rate Circuit” is any Highest Level Carrier Circuit (HLCC) or any Circuit that is not Contained by a Carrier Circuit.

The “Properties” of a Class consist of a set of zero or more Behaviors and a set of zero or more Attributes associated with those Entities belonging to the Class.

A “Proto-Behavior” is any set of Attributes that 1) references only Behaviors that are described by the set and 2) contains exactly two Attributes that reference different Entities that are not described by the set. The values of the two Entity referencing Attributes, together with the value of at least one other Attribute that is also a member of the same set may or may not uniquely identify the Behavior.

A “Proto-Entity” is a set of Attributes that reference only Entities, Proto-Entities, Behaviors, or Attributes that are elements of the set. A Proto-Entity is not uniquely identifiable.

A “Quaternary Subordinate Circuit” is the Direct Subordinate Circuit for a Tertiary Subordinate Circuit of one and only one Carrier Network Service.

A “Quaternary Subordinate Network Service” is the Direct Subordinate Network Service for a Tertiary Subordinate Network Service of one and only one Carrier Network Service.

A “Redundant Circuit” is any Circuit Aggregation that transmits, or is capable of transmitting, more than one identical information stream between the same set of Terminators.

A “Relationship” is an Entity whose Attributes describe an association between two Entities. Where Entities are depicted as Entities on a Graph, the relationships are depicted as Behaviors.

A “Ring Circuit,” or “Ring” is any Aggregation of identical and (usually) diverse Circuits, connected in series, wherein the last Circuit in the series connects to the first Circuit in the series. All Ring Circuits can be represented as a Graphical Loop on a Connectivity Graph.

A “Routed Network” is any SDN that has no logical Circuit information describing the communication path between individual ASPs.

An “SDN Boundary” is defined and described by the SDN's ASPs. An SDN Boundary is an SDN component.

A “SDN Route” is that particular subset of SDN Components required to support the SDN's Services between any two or more ASPs. All SDN Routes conform to the definition of an Entity.

An “SDN-Set” refers to any SDN constructed from two or more SDNs that share one or more common ASP and have at least one Service Capability in common. The ASPs of any SDN Set are defined as the union of all of the ASPs belonging to the SDNs making up the SDN Set, exclusive of all ASPs held in common between any two of the SDNs. An SDN-Set is an SDN component.

A “Secondary Subordinate Circuit” is the Direct Subordinate Circuit of another Direct Subordinate Circuit of one and only one Carrier Network Service.

A “Secondary Subordinate Network Service” is the Direct Subordinate Circuit of another Direct Subordinate Network Service of one and only one Carrier Network Service.

A “Service” is any task, series of tasks, or continuous performance of a task, performed by one Entity for another Entity.

A “Service Delivery Network,” or “SDN” is any collection of “SDN Components” (see below) that can be represented as a Connected Connectivity Graph. All SDNs conform to the definition of an Entity and to the definition of a Communications Network Component.

A “Service Segment” is any SDN Service Capability that is delivered to an SDN customer. Any Aggregate SDN may provide a Service-Segment to another more complex Aggregate Network. A Network cannot provide a Service segment to itself. A Service Segment is an SDN component.

A “Span” is any Network Component that can be associated with bridging the space (whether Physical or Logical) between two, or more, Terminators. All Spans conform to the definition of an Entity. A Span is an SDN component.

A “Statically Routed Network” is any Routed Network that requires only static (i.e., fixed for long periods of time) Routing instructions.

A “Strata” is a set of similar Network Components. There are three “Strata,” the “Geographic Strata,” the “Physical Strata,” and the “Logical Strata.” All Strata conform to the definition of an Entity. A Strata is an SDN component.

“Structural Representation” is defined as a model of the Network in terms of hardware and/or connectivity.

“Structural Utilization” is calculated solely and directly from Inventory Attributes by summing one or more Consumption Attributes.

A “Sub-Class” is a class that is based upon another class.

A “Subordinate Circuit” refers to each lesser information stream, within a specified Carrier Circuit, that is associated with an individual Circuit identifier and treated as a Circuit. Such Subordinate Circuits are said to be Contained within, and Subordinate to, the Carrier Circuit, subject to the following definitions and rules:

A “Subordinate Network Service” refers to each lesser information stream, within a specified Carrier Network Service, that is associated with an individual Network Service identifier and treated as a Network Service. Such Subordinate Network Services are said to be Contained within, and Subordinate to, the Carrier Network Service, subject to the following definitions and rules:

A “Super-Class” is a class that is not based upon another class.

A “Switched Circuit” is any Circuit that is assumed to have a relatively short lifetime and is usually established through a signaling protocol initiated at the originating end of the Circuit.

A “Switched Network Service ” is any Network Service that is assumed to have a relatively short lifetime and is usually established through a signaling protocol initiated at the originating end of the Network Service.

A “Terminator” is any Network Component that is associated with a Location, Physical Element, or Logical Element on a Communications Network. All Terminators conform to the definition of an Entity. A Terminator is an SDN component.

A “Tertiary Subordinate Circuit” is the Direct Subordinate Circuit of a Secondary Subordinate Circuit of one and only one Carrier Network Service.

A “Tertiary Subordinate Network Service” is the Direct Subordinate Network Service of a Secondary Subordinate Circuit of one and only one Carrier Network Service.

A “Trunk Group” is any Circuit Aggregation that is not a Circuit Set, Circuit Ring, or Redundant Circuit. Trunk Groups are used to determine whether two sets of Circuits use the same network Aggregations.

A “Type” is any subset of one or more Entities—taken from a potentially larger set of Entities—that 1) have one or more Attribute Values in common and 2) are differentiated from all of the other Entities in the potentially larger set of Entities by the same one or more Attribute Values. A Type is an SDN component

A “Type I Communication Service Capability” refers to any Communication Service Capability based on Permanent Circuits (whether Physical or Logical) where the SDN Route of each such Circuit is fully described in the Inventory module of the present invention.

A “Type 2 Communication Service Capability” refers to any Communication Service Capability based on Switched Circuits (whether Physical or Logical), connectionless routing methodologies, or Permanent Circuits (whether Physical or Logical) where the SDN Route of each such Circuit is not fully described in the Inventory section of the present invention.

A “Type Domain” Is a Diversity Domain that is specified by all Communication Network Components having a specified Attribute Value, or set of Attribute Values, in common.

“Utilization” is a set of Attributes describing the percentage of one of an Entity's Capacity Attributes that is in one of the possible states associated with each of its consuming Entities. If no state Attribute is specified, Utilization refers to the sum of a particular consumption Attribute over all of the Consuming Entities, regardless of their state, that is divided by the corresponding capacity of the Entity being consumed.

“Value” is defined as some type of information pertaining to an attribute of a specific entity, behavior or information.

“Warehouse Representation” is a structured paradigm for reporting representations of large amounts of information of various types.

Rules Governing Definitions

2a. Rules Defining Behaviors

The Rule for Hierarchical Behaviors: If a first Entity, A, has a Hierarchical Behavior with a second Entity, B, then the second Entity, B, must also have a reciprocal and non-identical Behavior with the first Entity, A.

Rule for Peer Behaviors: If a first Entity, A, has a Peer Behavior with a second Entity, B, then the second Entity, B, must also have an identical Peer Behavior with the first Entity, A. There is no directionality implied in a Peer Behavior.

2b. Rules Governing Hierarchies

For a Hierarchy to exist, the following Rules apply:

Rule 1: all Contained elements or Component elements (eg, Terminators or Spans) may be a Primary (or 1st) Component of one and only one Container that must also be an element of the Hierarchy.

Rule 2: a Container may, but is not required to, be a Component of another Container.

Rule 3: the sum of the Capacities (not necessarily Physical Capacities) of all Primary Components that are Contained within a single Container cannot exceed the Capacity of the Container.

Rule 4: if a first Component element, B, is a Primary Component of a second element, A, and a third element, C, is a Primary Component of B, then C is a Secondary (or 2nd) Component of A, for all elements of the Hierarchy.

Rule 5: if a first Component element, C, is a Secondary Component of a second element, A, and a third Component, D, is a Primary Component of C, then D is a Tertiary (or 3rd) Component of A, for all elements of the Hierarchy.

Rule 7. if a first element, Z, is an n^{th} Component of a second element, B, and B is a Primary Component of a third element, A, then Z is an (n+1)^{th} Component of A, for all elements of the Hierarchy.

Rule 8: if a first Component, Z, is an n^{th} Component of a second element, A, then Z is Contained in the Hierarchy of A, for all elements of the Hierarchy.

2c. Rules Governing Network Service (Circuit) Hierarchies

Rule 1: a Subordinate Circuit may be a “Direct” (or 1st) Subordinate of one and only one Carrier Network Service.

Rule 2: a Carrier Network Service may, but is not required to, be a Subordinate Network Service of another Carrier Network Service.

Rule 3: a Subordinate Network Service must terminate within the Hierarchy of the Terminators associated with its Carrier Network Service's Terminal Ends.

Rule 4: the sum of the Capacities (not necessarily physical Capacities) of all Direct Subordinate Network Services, contained within a single Carrier Network Service, cannot exceed the Capacity of the Carrier Network Service.

Rule 5: if a first Network Service, B, is a Direct Subordinate Network Service of a second Network Service, A, and a third Network Service, C, is a Direct Subordinate Network Service of B, then C is a Secondary (or 2nd) Subordinate Network Service of A.

Rule 6: if a first Subordinate Network Service, C, is a Secondary Subordinate Network Service of a second Network Service, A, and a third Subordinate Network Service, D, is a Direct Subordinate Network Service of C, then D is a Tertiary (or 3rd) Subordinate Network Service of A.

Rule 7: if a first Circuit, Z, is an n^{th} Subordinate Network Service of a second Network Service, B, and B is a Direct Subordinate Network Service of a third Network Service, A, then Z is an (n+1)^{th} Subordinate Network Service of A.

Rule 8: if a first Subordinate Network Service, Z, is an n^{th} Subordinate of a second Network Service, A, then Z is contained in the Hierarchy of A.

2d. Rules Governing Pathway, Cable, and Network Service Aggregations

Rule 1: if a first Pathway, Cable, and/or Network Service, A, is a Component of a second Pathway, Cable, and/or Network Service (respectively), B, and if B is a Component of another Pathway, Cable, and/or Network Service (respectively), C, then A is also a Component of C.

Rule 2: if a first Pathway, Cable, and/or Network Service, A, is a Component of a second Pathway, Cable, and/or Circuit (respectively), B, and if C is an Aggregate Pathway, Cable, and/or Network Service (respectively) of the same Type as B, then A cannot be a Component of C, unless B is also a Component of C.

Rule 3: a Pathway, Cable, and/or Circuit cannot be a Component of itself.

2e. Fundamental Rules Governing Specific Communication Network Components

Rules about Locations: a Location may Contain only one or more other Locations and/or Physical Elements depending on its Type. A Location may be Connected only to one or more Pathway-Segments, depending on their corresponding Types.

Rules about Pathways: a Pathway may Contain only one or more other Pathways and/or Cables depending on its Type.

A Pathway-Segment may be Connected only to Locations, depending on their corresponding Types.

A Pathway-Set cannot be directly Connected to any other Communication Network Component, except through the Behaviors of its Component Pathways.

A Physical Element may Contain only one or more other Physical Elements and/or Logical Elements depending on its Type.

A Physical Port may be Connected only to one Cable-Segment, depending on their corresponding Types.

A Physical Port may be Contained only by another Physical Element that is not a Physical Port.

A Cable may Contain only one or more other Cables and/or Circuits depending on its Type.

A Cable-Segment may be Connected only to Physical Elements, depending on their corresponding Types.

A Cable-Set cannot be directly Connected to any other Communication Network Component, except through the Behaviors of its Component Cables.

A Logical Element may Contain only one or more other Logical Elements depending on its Type.

A Logical Port may be Connected only to one Circuit-Segment, depending on their corresponding Types.

A Network Service may Contain only one or more other Network Services depending on its Type.

A Network Service-Segment may be Connected only to Logical Ports, depending on their corresponding Types.

A Network Service-Set cannot be directly Connected to any other Communication Network Component, except through the Behaviors of its Component Network Services.

All Service Delivery Networks (SDNS) must form Layers when represented as Connectivity Graphs.

The rule for propagating Communication Network Component Cost Attributes is that the Value of each Cost Attribute of an Aggregate Communications Network Component shall be equal to the sum of the values of the cost Attributes of its Components (where no Component will be counted twice). The Value of each Cost Attribute of a Direct Subordinate Communication Network Component shall be determined by calculating the pro-rata portion of the Container Communication Network Component and multiplying it by the value of the same Attribute of the Container Communication Network Component.

2f. Components of a Complex Network

Most telecommunication networks consist of elements that can have one of three types of Relationships: Hierarchical, Point-to-Point; and Concatenation. A Hierarchical set of Network Elements would be a Network device that contains several sub-systems, where each sub-system contains other sub-components. An example of a Hierarchical set of Network Elements would be a card cage. Card cages contain printed circuit cards. Printer circuit cards in turn contain Physical Ports. An example of a point-to-point connection would be a Cable that connects a Physical Port on one device to a Physical Port on another device. An example of a Concatenation Relationship is the interconnection of a number of shorter circuits to form a more complex circuit that connects multiple locations, Network Elements, and the like. By tracking all such Relationships within a Network, a user (person or software program) can determine the impact of a failure of one small piece of equipment (e g, a Physical Port) on the customers of the Network. Today, the modeling of simple Network configuration information has been accomplished by the ad hoc construction of many application specific models. Until the present invention, no model existed where an arbitrary complex Network configuration could be decomposed and its Components organized into a common data structure regardless of the Component type, Network service, or application.

The method of the preferred embodiment of the present invention is based on the desire to utilize some elements of Graph theory to describe and to model the configuration data for most (if not all) real-world Networks including complex Networks. The benefit of such an effort is that the large body of mathematics and computer algorithms—already developed for use in the field of Graph theory—can then be utilized independent of the particular Network application. Unlike the present invention, most prior art general-purpose computer systems and algorithms have been designed to take advantage of information that can be expressed as a single simple Graph.

However, real-world Networks are typically too complex to be represented as a simple Graph. Instead, real-world Networks must typically be depicted as a diverse and complex set of Entities and Behaviors belonging to many different classes. This diversity and complexity makes it very difficult to design computer systems and algorithms that can deal with the many tasks associated with managing such information.

The present invention provides a framework and paradigm for reducing any Network to a set of related simple Graphs. The method of the present invention set forth can be accomplished in a series of sequential steps or may be employed on a piece-wise or iterative fashion.

It is a presumption of the present invention that any real-world Network can be modeled by reducing the Network configuration data to a set of interrelated simple connectivity and Hierarchical Graphs. The benefit of the application of the method of the present invention is that generic computer systems and algorithms can be utilized to perform many of the tasks associated with managing such Network configuration data.

3. The Method of the Present Invention

This section discloses the manner and process of an embodiment of the method of the present invention so as to enable any person skilled in the art to which it pertains, or with which it is most nearly connected, to use, and benefit from the same.

The invention is best described as a distillation process, whereby a set of arbitrary information is organized into a set of Entities and a set of Behaviors that can be further separated into a set of structural information and a set of descriptive information. This organization of the information can then be used as a basis for replicating the more meaningful portions of the information across internal and/or external enterprise boundaries. The method described below explains the sequence of logical steps that comprise the method. The method itself can be outlined in several main steps, namely:

1. Transforming any original information set into subsets of Entities, Proto-Entities, Behaviors, and Proto-Behaviors;

2. Uniquely identifying the Proto-Entities and the Proto-Behaviors;

3. Identifying the Structural Attributes for each Entity and each Behavior;

4. Forming Charts from the Attribute sets; and

5. Mapping the Charts to database tables.

Each of these steps is discussed in detail below.

3a. Transforming any Original Information Set into Subsets of Entities, Proto-Entities, Behaviors, and Proto-Behaviors

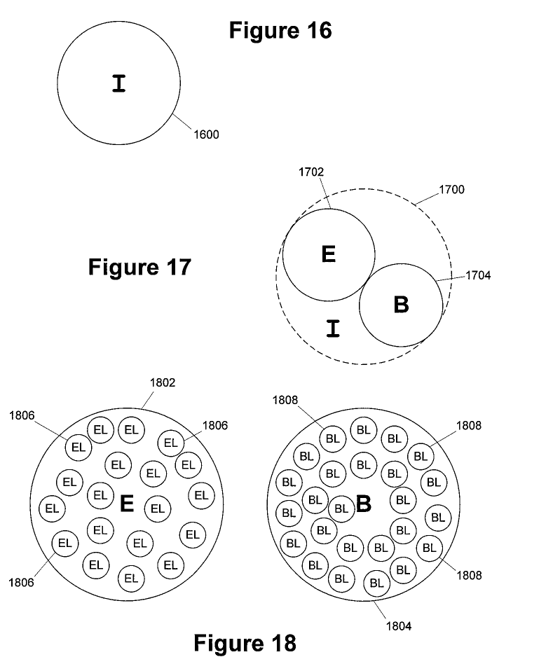

Any arbitrary set of information (the “original information set,” or “I” 1600 of FIG. 16) can be divided into a set of Entity, or Proto-Entity Attributes and a set of Behavior, or Proto-Behavior Attributes by the method described herein. The original information set 1700 of FIG. 17 can be separated into two and only two characteristically different groups, namely the set of Entities 1702 and the set of Behaviors 1704. Referring now to FIG. 18:

1) the first group, “E,” 1802 of FIG. 18 will be comprised of all possible recognizable sub-sets of I (see FIGS. 16 and 17), wherein the information contained within each such sub-set of E 1802 pertains to that sub-set and that sub-set only, and a list “LE” 1806 exists that comprises all such sub-sets of E 1802, where each element of LE 1806 is different from all other elements of LE 1806, although perhaps not uniquely different, which can be otherwise expressed as the equation:

$$E = {⋃}_{j = 1}^{m} {EL}_{i}$$

and

2) the second group, “B,” 1804 will be comprised of all possible recognizable sub-sets of I (see FIGS. 16 and 17), wherein the information contained within each such sub-set of B 1804 pertains to one and only one relationship between two and only two of the elements of LE 1806, and a list “LB” 1808 exists that comprises all such sub-sets of B 1804, where each element of LB 1808 is different from all other elements of LB 1808, although perhaps not uniquely different, which can be otherwise expressed as the equation:

$$B = {⋃}_{j = 1}^{m} {BL}_{i}$$

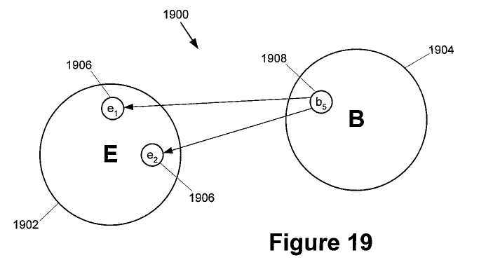

The relation of Behaviors to Entities is illustrated in FIG. 19. As FIG. 19 illustrates, the set I 1900 has both the set of Entities 1902 and the set of Behaviors 1904. Two Entities e₁ and e₂ 1906 are referenced by a single Behavior b₅ 1908 as illustrated in FIG. 19. The Behavior b₅ 1908 is indicative of one and only one relationship specific to the two Entities e₁ and e₂.

Finally, the set of information I can be expressed as the equation:

I=E∪B

It should be noted that it is permissible to duplicate any information in I that is required to form E and B, and to form any of the sub-sets contained in the lists, LE, and LB. The information content of each element of LE, shall be referred to herein as “intrinsic” information and the information content of each element of LB, shall be referred to herein as “associative” information.

The total information content of each-and-every element of LE and LB must now be identified, organized, and labeled, and no such information shall be left unidentified, unorganized, and/or unlabeled. The information required for labeling may already be contained within, or it may be arbitrarily added to the information content of, each element of LE and LB The result of this labeling process is that the contents of each element of LE and LB are now organized into a set of labels and a set of information that corresponds to each such label. For purposes of this discussion, a “Label” is any first unit of information that is used to uniquely identify a second unit of information. Each label is referred to herein as an “Attribute” and the information it identifies is referred to as its “value” Each Attribute thus constructed within each element of LE shall be an “intrinsic” Attribute, by definition. Each Attribute thus constructed in each element of LB shall be an “associative” Attribute, by definition. If possible, the number of elements in LE and LB may be reduced at this stage by eliminating those elements of LE and/or LB that that are aggregations of other elements and are not required to fully contain all of the information in I, subject to the constraints of the process just described.

The remaining elements of LE and LB can now be separated without duplication into those elements that can be uniquely identified and those that cannot be uniquely identified. Those elements of LE that can be uniquely identified are “Entities,” by definition, and those elements of LB that can be uniquely identified are “Behaviors,” also by definition. Those elements of LE that cannot be uniquely identified are “Proto-Entities,” by definition, and those elements of LB that cannot be uniquely identified are “Proto-Behaviors,” also by definition.

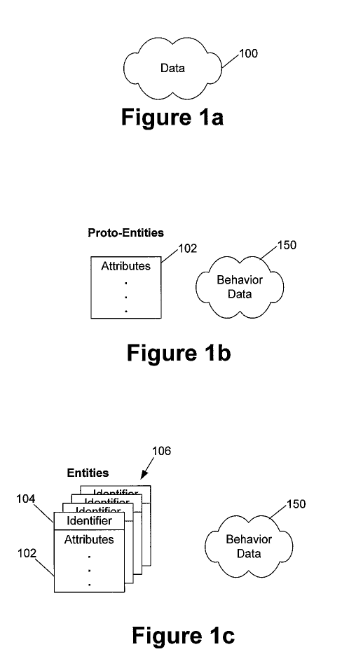

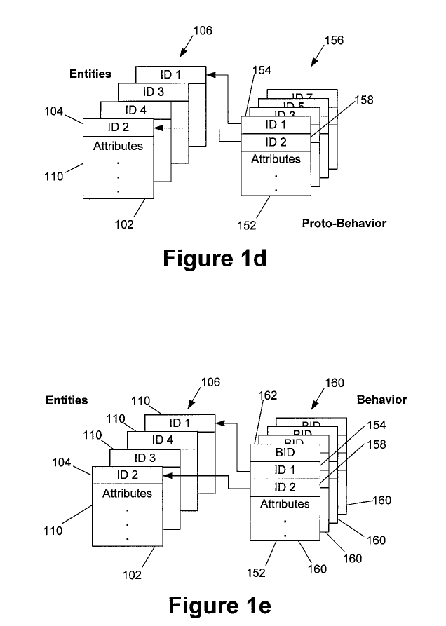

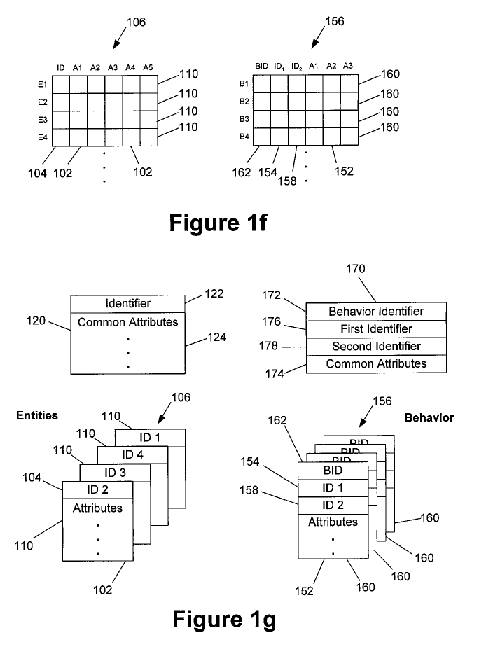

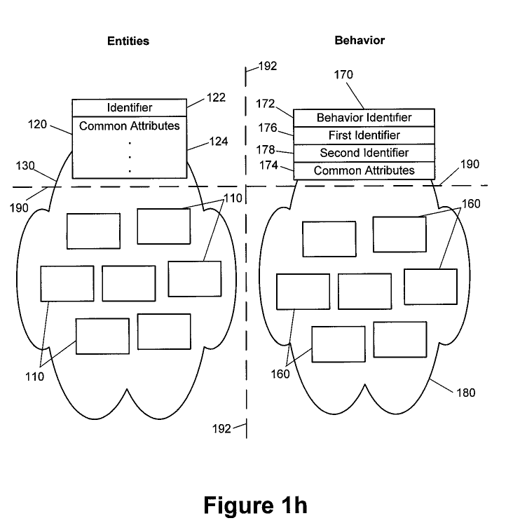

The set, I, has thus been organized into set of Entities, Proto-Entities, Behaviors, and/or Proto-Behaviors, each consisting of a set of Attributes. For a depiction of this organization, see FIG. 1b-1d. The general nature of the method thus far has not reduced the generality of the overall method and has not excluded any elements of the original information set, I.

3b. Uniquely Identifying the Proto-Entities and Proto-Behaviors

The next step in the method is to transform every Proto-Entity and every Proto-Behavior into Entities and Behaviors, respectively. There are two ways to uniquely identify Proto-Entities, and/or Proto-Behaviors. The first is to arbitrarily give a unique Identifying Attribute to each Proto-Entity and each Proto-Behavior. The second is to create a set of Attributes within each such Proto-Entity and/or Proto-Behavior—with Values that uniquely identify the Entity and/or Behavior. This is easily accomplished by adding an arbitrary set of Attributes to each Proto-Entity and/or to each Proto-Behavior in such a manner as to render each such Proto-Entity and each such Proto-Behavior unique. Since uniqueness is the only differentiator between Entities and Proto-Entities, and between Behaviors and Proto-Behaviors, all Proto-Entities, and all Proto-Behaviors have—by this process—now been transformed into Entities and Behaviors, respectively.

3c. Identifying the Structural Attributes for Each Entity and Behavior

In a given original set of information, there can be an arbitrarily large number of Entities and Behaviors. Management of the information in this form may be difficult, or even impossible, due to the potentially large numbers of Entities, Behaviors, and/or Attributes. Therefore, a further step is taken to identify, and then isolate those Attributes that are required to establish the uniqueness of each-and-every Entity and each-and-every Behavior. This process begins by normalizing the Attribute set required to establish the uniqueness of each Entity and/or Behavior. This is accomplished by adding an appropriate minimum set of zero or more Attributes—each with a null value—to each Entity and each Behavior so that all Entities have the same set of Attributes that establish each Entity's uniqueness and all Behaviors have the same set of Attributes that establish each Behavior's uniqueness. Since the Values associated with the added Attributes are null, each Entity and/or Behavior suffers no loss of uniqueness, or other detrimental effect on its original set of Attributes, by virtue of this process. A minimum set of Attributes—common to every Entity—has now been identified by which every Entity can be uniquely identified. The same is true for the set of all Behaviors.

Each such set of common Attributes is referred to herein as the “Identifying Attribute Set,” and the elements of such a set are referred to as the Identifying Attributes. Thus, there is one set of Identifying Attributes for all Entities, and one set of Identifying Attributes for all Behaviors. It should be noted that the set of Identifying Attributes for all Entities is not identical to the set of Identifying Attributes for all Behaviors.

A further step is now taken to create a new and separate list of Entities where each Entity contains only the Identifying Attributes for each-and-every corresponding original Entity. The new set of Entities is referred to herein as a “Structural Representation” of the original Entities. In a similar manner, a Structural Representation of the original Behaviors can also be created. Thus, each-and-every Entity and each-and-every Behavior now has two representations: its Structural Representation that contains only its Identifying Attributes and its original representation that contains its entire set of Attributes. The original set of Entities shall hereafter be referred to as the Entity “Warehouse Representation,” and the original set of Behaviors shall be referred to as the Behavior “Warehouse Representation.”

Finally, those Entities in the Warehouse Representation that have only Identifying Attributes and do not have any other Attributes can now be removed from the Warehouse Representation. The same process can be performed on the Behavior Warehouse Representation. Thus, the Structural Representation of an Entity consists of a set of its Identifying Attributes, and the Warehouse Representation of the same Entity consists of Entity's Identifying Attributes plus at least one other Attribute, or no Warehouse Representation at all. Similarly, the Structural Representation of a Behavior consists of a set of its Identifying Attributes, and the Warehouse Representation of the same Behavior consists of the Behavior's Identifying Attributes plus at least one other Attribute, or no Warehouse Representation at all.

The Identifying Attributes for Behaviors, however, must consist of at least two disjoint sub-sets of one or more Attributes, where each of the one or more Attributes is each identical in name and Value to the Identifying Attributes of each of the two and only two Entities to which the Behavior refers, plus one Behavior-type Attribute, plus zero or more Attributes as required to establish the uniqueness of each Behavior. Not all Entities need be referenced by a Behavior. Any Entity that is not referenced by a Behavior is referred to herein as a “disjoint” entity, meaning that it has no logical intersection, or Behavior with, the original set of Entities. Further, there may be sets of behaviors wherein all Behaviors within the set reference a set of Entities within a second set, wherein all Behaviors outside the set do not reference any Entities within the second set. Such sets of Entities and Behaviors are called disjoint sets because they have no relationship to that information not within their respective sets.

3d. Forming Charts from the Attribute Sets

From the Structural Representation of all Entities, a Chart can be formed. Each column on such a Chart will correspond to one of the Entities' Identifying Attributes and there will be a column on the Chart for every Identifying Attribute contained in each Entity. Given this mapping of Chart columns to Attributes, each-and-every Entity in the set is easily mapped into a single row on the Chart. When this mapping process is complete, the Chart will contain a row for every Entity. Thus the entire set of Identifying Attributes for all Entities can be reduced to a single Chart where the intersection of every column and row contains the corresponding Value of a particular Identifying Attribute for a particular Entity.

In exactly the same fashion, a similar Chart can be constructed from the Structural Representation of all Behaviors. The charting of warehouse Attributes can be carried out in a different manner. It may be possible to minimize the size of the Entity and/or Behavior Warehouse. If it is desirable to minimize the Warehouse, this is accomplished by eliminating all non-Identifying Attributes having a null Value from each-and-every Entity's, and/or each-and-every Behavior's set of Warehouse Attributes. The set of Warehouse Attributes for each Entity and/or Behavior now includes only those Attributes required to fully express the information contained in the original information set and the Entity Warehouse is therefore minimized.

The Entity Warehouse and the Behavior Warehouse can now be formed into one or more Charts each. This can be done in any manner that results in a set of Charts where each Chart has at least one column for each Identifying Attribute. For Entity Charts, there must be one and only one column corresponding to each of the Identifying Attributes for Entities; for Behavior Charts, there must be one and only one column corresponding to each Identifying Attribute for Behaviors.

One of many possible methods for forming such Warehouse Charts is to create groups of Entities and/or Behaviors, wherein all of the Entities and/or Behaviors in each such group must have the same set of Attributes. In the worst case, there will be one group per Entity and/or Behavior. A Chart can now be formed for each of these groups and populated in the same manner as described for the Structural Representation Charts.

The number and nature of the Charts formed from each Warehouse is arbitrary. Null Values are permitted, and redundant Attributes and their corresponding Values are also permitted in the Warehouse Charts.

3e. Mapping the Charts to Database Tables

Each Chart formed as described above can now be mapped directly into a database table. Each Chart formed from the Structural Representations shall be referred to herein as a Structural Table, and every Chart formed from the Warehouse Representations shall be referred to as a Warehouse Table. For any database there can be many non-redundant Warehouse Tables.

The benefit of following this method is that the Warehouse Tables may be separated into as many physical databases as required for any given application. As long as there is always at least one set of Structural Tables (one Entity Table and one Behavior Table) replicated across all such physical databases, the essential organization of the original information remains intact. Warehouse Tables may or may not be replicated, all as required for the intended application. All tables may be partially replicated if the Identifying Attributes contained in the partially replicated Warehouse also appear in the corresponding Structural Table.

The method described herein will always result in a data structure that is easily adapted to a distributed database environment. If the volume of information in the warehouse is substantially larger than the information contained in the structural tables, the problems that will be encountered when distributing such a database of information across a large enterprise, or across a large geographic area, can be minimized.

3f. An alternate embodiment of the Method of the Present Invention

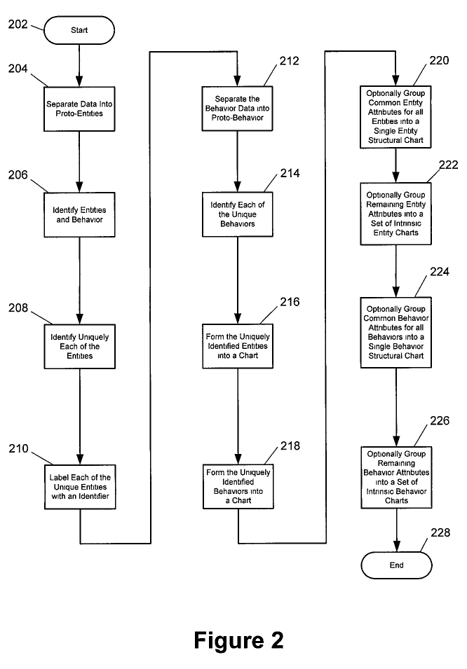

Another embodiment of the method of the present invention is illustrated in FIG. 2. However, it is helpful to refer to FIG. 1a through FIG. 1h for specific apparatus elements. The method starts generally at step 202. First, in step 204, the data 100 (FIG. 1a) is separated into Proto-Entities 102 and Behavior data 150 (FIG. 1b). At this point, each Proto-Entity 102 consists of a series of one or more Attributes and corresponding values that encompass the non-behavioral elements within the data 100. Next, in step 1406, each of the unique Proto-Entities 102 are identified. In step 1408, each of the Proto-Entities 102 are provided with a unique identifier 104 to form an Entity 106. The unique identifier 104 (of FIG. 1c) can be provided by assignment or by discernment (meaning that the Entity is unique by virtue of the disparate values of its Attributes). Assignment of identifiers can be by any number of methods, preferably automatically by an auto-increment feature that is provided in some relational database software packages, by an algorithm that uses the unique set of Entity-Attribute values 102 for each Entity 106, or by manual assignment (labeling) of a unique identifier for each Entity 106 by an operator (either human or artificial) in step 210.

Once the Entities 106 have been identified and tagged, attention can be directed to the Behavior data 150. In step 212, the Behavior data is divided into a set of individual Proto-Behavior 156. Each Proto-Behavior 156 has one or more Attributes 152, and identifies two or more Entities 106 in the two Identifier Containers 154, 158, see FIG. 1d. Next, in step 214, each of the unique Behaviors is identified. Thereafter each of the uniquely identified Entities is grouped into a chart, step 216. Similarly, all of the uniquely identified Behaviors are formed into another chart, step 218. The previous steps are the core steps needed to enable the present invention to operate. The Entity Chart and the Behavior Chart can be used and replicated to provide a rich source of information about the Network that it models However, there are optional steps that may be taken in order to extend the functionality of the present invention.

The method of the present invention illustrated in FIG. 2 can be extended to step 220, where all of the Entity Attributes that are common to all Entities are grouped into a single Entity Structural Chart. All of the remaining (non-common) Entity Attributes can then be grouped into a set Intrinsic Entity Charts, step 222. These last two steps can be duplicated for the various Behaviors. For instance, all of the Behavior Attributes that are common to all Behaviors can be grouped into a single Behavior Structural Chart, step 224. Likewise, all of the remaining Behavior Attributes can be grouped into a set of Intrinsic Behavior Charts, step 226. Thereafter, the method ends generally at step 228.

The Intrinsic Entity Charts and the Intrinsic Behavior Charts can be divided into departmental (sub-organizational) portions that are replicated or otherwise distributed within the organization. The intrinsic Charts need contain only that information that is peculiar to that department. Along with any Intrinsic Charts, the Entity Structural Chart and the Behavior Structural Chart must also be provided or otherwise accessible.

One consequence—and benefit—of rigorously applying the method of the present invention is that the user is unable to include any Entity more than once within a Layer and/or within a simple Hierarchical Graph. Having an Entity defined more than once is an indication of potential incompleteness in the data collection effort. However, while such completeness is desirable, it is not required.

In general, the method of the present invention is an abstraction process wherein Entities of a Network are rigorously classified and their interacting Behavior identified. The Behavioral features of the Network are themselves classified (as Behaviors) and arranged according to those classifications. Once the abstraction method of the present invention is complete, a distilled structure of the Network emerges. This structural model can then be separated from the underlying data, replicated and distributed throughout the organization and/or to third parties.

According to the method of the present invention, an Attribute is a named value (or parameter). Some Attributes pertain to one and only one Entity. These are Entity Attributes. Some Attributes pertain only to an association between two and only two Entities. These are Behavioral Attributes. With this simple structure all information “piles” can be organized into two large groups: Entity Attributes and Behavioral Attributes. Each of these two groups can be further organized (split) into two groups each. The Entity Attribute group can be organized into “Proto-Entities” and Entities. The Behavioral Attribute group can be organized into “Proto-Behaviors” and Behaviors.

Proto-Entities can be transformed into Entities by adding a unique identifier to each of their Attribute sets. Likewise, Proto-Behaviors can be transformed into Behaviors by adding a unique identifier to each of their Attribute sets.

After transforming all Proto-Entities and Proto-Behaviors into Entities and Behaviors, respectively, each-and-every Entity and each-and-every Behavior, can now be uniquely identified. Further, there now exists a closed set, where every Behavior references only Entities that are in the set of Entities. This is always true because all Behavior identifiers consist of at least two and only two Entity identifiers. Given that an Entity identifier exists within a Behavior identifier, one would also have at least an Entity identifier (e.g, a unique key), but since an identifier is an Attribute that refers to one and only one Entity, the requirement for the existence of an Entity is satisfied. This results in a closed set of unique Entities and unique Behaviors.

Thereafter, each Entity can be separated into two Attribute sets: the first Attribute set will contain only that minimum set of Attributes that are required to establish the uniqueness of each Entity (which is called the uniqueness Attributes); the second Attribute set will contain all of each Entity's remaining Attributes. It can further be assured that the set of Attributes (not values) that is required to establish uniqueness is common to all Entities (if some Entities are allowed to have null values for one or more of their uniqueness Attributes).

Similarly, each Behavior can be separated into two Attribute sets: the first Attribute set will contain only that minimum set of Attributes that are required to establish the uniqueness of each Behavior; the second Attribute set will contain all of each Behavior's remaining Attributes. It is assured that the set of Attributes required to establish uniqueness is common to all Behaviors (if some Behaviors are allowed to have null values for one or more of their Uniqueness Attributes).

At the end of the method of the present invention, each set of Entities and Behaviors has been separated into two groups each. The first group—the Structure Group, consisting of a list of all Entities and a list of all Behaviors (defined by their Uniqueness Attributes)—describes only the existence of each Entity and Behavior within the original information set, but contains no Attributes that are not required to establish uniqueness. The second group contains only Attributes relating to an individual Entity or Behavior that do not point to, reference, or otherwise relate to any other Entity, or Behavior, and are not required to establish the Entity's or Behavior's uniqueness. The second group for each is called the “warehouse.”

At the end of the method of the present invention is a complete Structure Group, an Entity Warehouse, and a Behavior Warehouse. Specifically, the Structure Group can be expressed in “Chart” form, as can each of the Warehouses. These Charts can all be mapped into tables within a relational database, or objects within an object database. This form is optimal for constructing a distributed database containing the entire set of information from the “pile” of Network data available to the user. Each physical database can retain all of the Structure Group information and only that portion of the Warehouse of information that is required by the department or sub-organization using the database. While all departments use the same consistent structural information (from the Structure Group), they do not have to compete with other groups for access to a single monolithic physical database, nor do the database administrators have to replicate the entire database across the entire enterprise. The method of the present invention describes the minimum data required for replication, while retaining all of the relevant data for each department.

In situations where more than two Entities all share in a Behavior is easily mapped into the two-Entity form (described above) by establishing a unique Entity that is an Aggregate. Each of the more than two Entities is mapped into the Aggregate Entity via a two-Entity Behavior. Such a multi-Entity Behavior is always expressed as existing between two Entities, an individual Entity, and an Aggregate Entity. In this way, the method of the present invention can be equally effective for scenarios where three or more Entities are involved in a single Behavior instance.

The benefit of the method of the present invention is that it reduces the amount of information needed to manage the network model down to an abstraction of the structure of the Network in question. Once the structure of the Network has been properly abstracted, a model of the structure can be constructed This structural model can then be replicated as needed along with specific subsets of Attributes about elements of the Network. As the most intractable problem with data consistency stems from a lack of common structure, the present invention, with its standardized structure, reduces considerably the problems with data consistency inherent in the prior art.

Ideally, the replication of the database only occurs on the Location (Structural Group) table (e.g, the table containing a copy of the unique primary and secondary keys). Although one can add additional data into the “Location” table, but doing so will degrade the performance of the Location table by making larger than necessary and impose the requirement of maintaining the coherency of the extra data for any of the non-common Attributes. Optimally, the Location table is kept as small as possible. If specific Attributes are needed, specific calls to the other tables (referencing the Location table) can be made.

One of the benefits of this data organization is that one can have completely different sets of Attributes for different replications of the main database, yet maintain the crucial parts of the original structure of the database. Moreover, “niche” databases can be created using a specific subset of the main database.

The data abstraction method of the present invention, is a method by which data is abstracted by a series of recursive procedures for the purpose of separating structured data from intrinsic data and to enable the replication of meaningful data across Network boundaries. Data models are simply ways of representing, organizing, and structuring information.

The apparatus of the present invention is best described as a distilled set of Charts, see FIG. 1h, that exists within as software and information within a suitable computer system. A group of structural Entities 120 and Behaviors 170 bare separate sets of intrinsic Entities and Behaviors that organize a compilation of meaningful and useful data that may be replicated across database boundaries. The methods described below, which explain the apparatus of the present invention are the preferable methods by which to organize the group of structural and intrinsic Entities and Behaviors.

3g. Translate Undefined Data into Entities and Behaviors

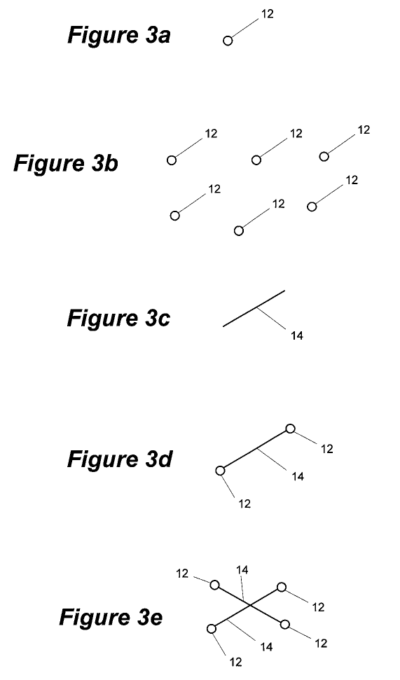

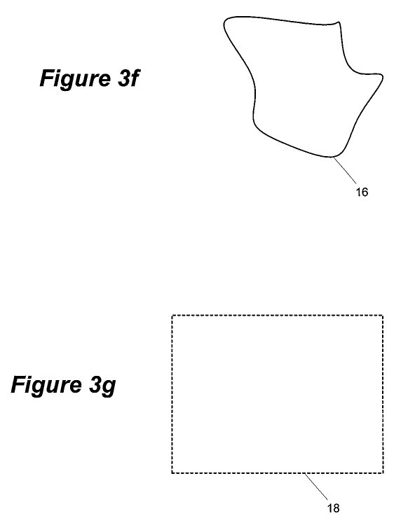

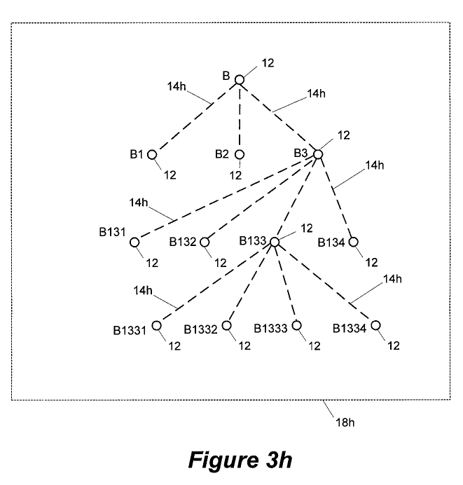

Undefined data is translated into Entities and Behaviors by a method of defining and separating data that can be related to: 1) the points of reference in a network; and 2) data that can be used to relate one point of reference to another point of reference in a Network. The data that can be related to points of references in Networks are Entities, see FIG. 3a. The data that can be used to relate one point of reference to another point of reference in Networks are Behaviors (FIG. 3c). Every Behavior must reference two, and only two Entities (FIG. 3d). Many Behaviors can be of the same Type. In other words, since a Behavior indicates the existence of a particular Relationship between two, and only two Entities, it would be redundant to have more than one such indicator of a given Type. Therefore, there can be only zero or one Behavior of a particular Type that terminates on the same two Entities.

Each Entity must have an associated set of descriptive parameters called “Attributes.” For example, one characteristic of a router is its IP address. Therefore, one Attribute of a router might be “IP address” with a value of “192.168.1.10.”

These Attributes define or make up the Behaviors that can join one Entity with another Entity. They create the rules of the Relationships between both Entities. Behaviors attach two Entities by joining or connecting the compatible Attribute names and values of the Intrinsic Attributes of each of the two Entities (this concept is further explained below). If the Intrinsic Attributes between the two Entities are compatible, or meet the rules for relating, then an Entity may connect to another Entity by way of a Behavior.

In a given structure, there can be an innumerable amount of Entities and Behaviors Therefore, it is important to accurately assign Intrinsic Attributes to Entities, and to precisely define Behaviors within the rules of the Relationships between the Entities.

3h. Uniquely Identify the Entities and Behaviors

Each Entity can have a set of Attributes that are used to describe the Entity's relevant characteristics, isolated from any other Entity, see FIG. 1c. These are “Intrinsic Attributes” because they describe a particular Entity, but do not describe any relationship between that Entity and any other Entity. Therefore, any Entity that has Behavior with respect to itself becomes Intrinsic information. In fact, the rules of Relationships, or the Behaviors, are based on one or more Intrinsic Attributes of either or both of the Entities.

Each Entity's set of intrinsic Attributes must have an Identifier and its associated value that is used to distinguish the Entities from other Entity's Intrinsic Attributes, see FIG. 1c. Consequently, no two Entities are permitted to have the same value for their intrinsic Attribute's Identifier.

There are two ways to uniquely identify Entities. The first method is by arbitrarily assigning a unique Identifier to each Entity or to each Entity's set of Intrinsic Attributes. The second is to pick or discern a set of Attributes that will uniquely define the Entity or that whose values will uniquely identify the Entity. The latter method is preferable, which is to identify each Entity through a set of Attributes that has unique values. By assigning a unique identifier using this method, every other Entity must have at least one of the Attributes of another Entity (although with a dissimilar set of values).

Just as each Entity must have a unique Identifier, each Behavior must also have a unique Identifier, see FIG. 1d. This is accomplished by assigning a Behavior an arbitrary label, or by taking a group of Intrinsic Attributes where each group has at least one of those Attributes and a unique value of it, and then using that group as a Behavior ID.

3i Aggregate Redundant Entity Attribute Names

At this point, it is possible to have several redundant Entity Attribute names, taken into account the amount of Intrinsic Attributes of a given Entity with the same Attribute names. To simplify these instances, note the list of Attribute names associated with all the Entities in a set. Afterwards, eliminate any redundant Attribute names to form an Aggregated Attribute list. The Aggregated Attribute list will result in one, and only one, Attribute name. Each Attribute name will correspond to the complete list of Intrinsic Attributes for one, and only one, Entity. All Entities with like Attribute names may now be grouped in a set, see FIG. 1h. Grouping the Entities in a set simplifies the formation of the Entity tables described in the next section. The concept behind this method is that if one Entity in a set can be described, then all Entities in the set can be described.

3j. Form Entity and Behavior Description Tables

Each Entity's Attribute set should be placed in a table format where each column describes one and only one Attribute name, and each row describes one and only one Entity, see FIG. #. The first column, however, should reflect an Identifier of those Attributes. The table allows any Entity to be fully described by referencing those Attributes contained in one or more sets of those tables.

The same process should be directed to Behaviors. Each Behavior's set of Identifiers and Attributes that references the entities should be organized where each column describes one and only one Attribute description, and each row describes one and only one Behavior. This allows for the Behaviors to be fully described by referencing those Attributes contained in one or more set of those tables.

3k. Group Common Attributes of Entities and Behaviors

The common Attributes should be grouped together into a single table, and the remaining Attributes in various other tables (for both Entities and Behaviors). Separating the common Attributes from the uncommon Attributes allows for the differentiation between data that will be identified as structural, and data that will be identified as intrinsic. The structural data becomes the data of reference for the intrinsic data. The structural data may be replicated across various database boundaries. This means that one or more tables of structural data (or an Entity's set of common Attributes) can reference any other Entity (or any Entity's set of uncommon Attributes). In essence, the structural data is the optimal point of replication. Everyone may use the structural information, but the intrinsic data is different from specific application to application.

3l. Example Application of the Method-Improving Corporate Productivity by Improving “Data Integrity”

Any computer program that uses a relational database for its data management can strongly benefit from the methodologies and principals of the present invention. The methods specified by the present invention enable non-communicative data to communicate in a more structured fashion that ensures data consistency. While many industries may benefit from the assurance of data integrity given by the present invention, an illustrative example is provided for the telecommunications industry. Telecommunication network configuration data represent one of the most complicated data management problems that exists today, and one of the most productive areas for applying the method of the present invention.

The single most critical problem facing most communications carriers today is “data integrity” Many people skilled in the art consider the problem of data integrity to be one of nature's “unsolvable mysteries” and have abandoned many efforts to ameliorate the problem. However, the effect of data errors on corporate productivity are so debilitating that to even small improvements in the availability, accuracy, and consistency of information can have dramatic effects on productivity.

Data errors are not the product of a poor operation. Rather, data errors are a result of how systems are built and modeled. The present invention overcomes the structural causes of data errors and enables a Network operation to begin to manage the huge volumes of information required to carry on a competitive business.

3m. Improving Corporate Productivity by Ensuring Data Integrity

Complex Networks comprise three general categories: computers (and the networking equipment that accompanies them), information (or data), and the software processes (i.e., computer applications) that manipulate the information. Software processes are typically application-specific and are usually patterned after proven manual processes. Certainly there can be improvements in the process that result from “automation” but the nature and scope of the software processes usually track closely the needs of each organization within the telecom carrier that have historically prevailed.

Telecom carriers are, first and foremost, in the information management business. All telecom services depend on the communication equipment that transmits the “communication signals.” However, the knowledge of what, how, and where signals are to be processed and transmitted is contained within the memory of the networking equipment and is placed there usually by another “system.” Installing and maintaining the telecom equipment is only a small part of the telecom business. Instead, the design and the implementation of systems that manage the millions and millions of parameters that must be transmitted to and/or stored within the equipment is the most critical function of the telecom carrier.

The information management problem for a complex Network can be classified into three areas. First, the information must be “accessed” (i.e., from its “source”) and made “accessible” to all those systems and personnel who need that information before the information can be useful. Finally, integrity must be addressed. Data integrity is based in good data models. Data models illustrate fundamental concepts within the carrier enterprise. The concept of a “Circuit” must invariably be tied to a data model. For example, every person's mental image of a Circuit is the result of some “data model.” The data model is an integral part of every system and every manual process. To correct any data model problems, one must first carefully define the problem to be solved. Usually, there is a concerted effort to reduce the scope of the problem to a “manageable” set of parameters that can be expressed as a set of requirements. Trying to solve a problem that is too broad will result in “cost” overruns or requirements that cannot be fully expressed in writing (within a reasonable period of time and effort). Therefore, the predominate method of describing a data model is to very carefully define the problem in as narrow a scope as possible without omitting any critical Component or aspect of the problem.

3n. Implementation of the Method of the Present Invention

This section discloses the manner and process of using the method of the present invention so as to enable any person skilled in the art to which it pertains, or with which it is most nearly connected, to use the same, and shall set forth the best mode contemplated by the inventor for carrying out the invention.

The present invention adheres to a set of fundamental networking principals and methodologies, and the implementation of the present invention follows a process that ensures completeness The principals and methodologies, which are described above, develop a well-organized set of Network Components and Behaviors, (The Network Information Model), to be managed by the invention. A Network Information Model must be built on a foundation of basic Network Components that are both extensible (i.e., can be used to describe any Component and Network) and comprehensive (i.e., excluding no important Network structures). The preferred embodiment of the present invention uses the 6 x 2 Framework model as a Network Information Model.

3o. The 6×2 Framework Network Information Model

The 6 ×2 Framework, hereafter referred to as “the framework,” consists of Network Components that together are adequate to describe any Network. It is the physical basis of the invention upon which all other aspects of the invention are included. The framework is application independent, Network Component independent, and Attribute independent, and is a common feature of every physical implementation of the present invention. It can be used to describe fully the complete structure of a Communications Network, e g, how the Network is organized, configured and interconnected, without carrying the added burden of Network Component, application, carrier and feature-specific Attributes (i.e., intrinsic or descriptive parameters).

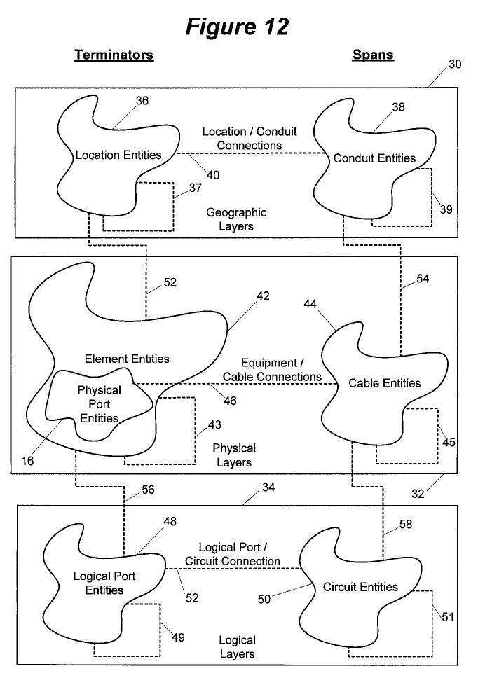

Network components, or the Components of a Communications Network, are Locations, Pathways, Physical Elements, Cables, Logical Elements and Services. The framework divides each Network Component into three “Strata” that describe related structures, see FIG. 12. The Strata are: Geographical (or Spatial) Components and Behaviors, Physical Components and Behaviors, and Logical Components and Behaviors, see FIG. 12. The Geographical Components and Behaviors Strata Include such Terminators and Spans that are best categorized as the Locations and Pathways. The Physical Components and Behaviors Strata include such Terminators and Spans that are best categorized as the Physical Elements and Cables. The Logical Components and Behavior Strata include such Terminators and Spans that are best categorized as the Logical Elements and Services. Each Stratum is further broken down into as many Layers as required to accurately describe the Network and the way it is used.

The Network Components are divided into two groups, see FIG. 12. The group forming a column on the left in FIG. 12 are Terminators because they “terminate” the Network Components in the right column. The Network Components in the right column of FIG. 12 are Spans, because they “span” the distance (whether a Physical Component or a Logical Component) between two, or more Terminators.

3p. Typing the Network Components (Entities and Behaviors)

Each of the Network Components can and should be further divided into Types. Types allow for the creation of impossible Relationships between the Network Components and are required to fully describe the Network Components. Types are contained in the Network Components. In the instances where an Entity is large and encompasses many Attribute values, Types alleviate the problem of Attribute extensiveness by allowing for a portion of the Attribute list to be incorporated into the Type. Therefore, Types represent groups of Network Components that have an attribute “group” character or behavior. Types can be as detailed or as general as necessary.

Types are made simply by taking a portion (or a continuation) of an Entity's Attribute list and grouping it into a separate set. The separate set then becomes the Type of an Entity. An important rule is that there is only one Type allowed per Network Component in the framework. This limitation is placed because several different types of Network Components, attempting to connect to, or be contained in, other Network Components can take away from the goal of the invention, which is to ensure data integrity and data accuracy.

3q. Associations between Network Components

Associations between Network Components allow for the communication between, or interaction of, two or more Network Components. The association between Network Components is at the core of the framework's functionality. It defines the Network Component Relationships that are necessary for the complete and successful operation of the overall Network, which ensures the integrity of the data output.

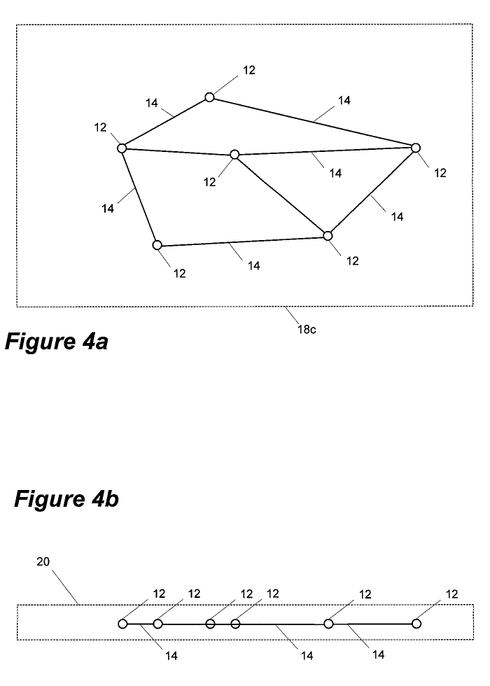

There are two ways to create effective associations between the Network Components. The first of these is Connectivity. To be “connected” is generally described as an association wherein one Network Component is “attached to” another. Most Network Components support multiple connectivity associations, but only as permitted by the physics of the framework. That is, only Terminators and Spans of a similar Stratum can be connected to one another. For example, a Location cannot be connected to a Cable (only Pathways can be connected to Locations, and then only if the particular Pathway and Location are compatible); nor can a Circuit be connected to a Physical Port (only cables can be connected to Physical Ports, and then only if the connectors associated with each Network Component are compatible). Connectivity associations can be further subdivided into two sub-classes: the first is connectivity between Terminators and Spans; the second is Connectivity between one Span and another Span of a compatible Type, see FIG. 4a. The second sub-class can be further subdivided into serial (these associations are called “sets” and are required to be non-Looping sets of two or more other Spans), parallel, and ring connectivity associations between Spans.

The second type of association known to the framework is Containment. Containment is a Hierarchical association between two Network Components wherein one Network Component exists wholly inside another Network Component. Examples of Containment include a card cage that contains a printed circuit board and a Cable that contains a Circuit. Containment associations can exist wholly within a single Strata. Examples include a building (a type of Location) that contains a room (another type of Location). Containment associations can also exist between compatible Network Components that exist in different Strata. Examples of inter-Strata Containment include a Physical Port that contains one Logical Port, and a conduit (a type of Pathway) that contains a Cable, see FIG. 3h. Containment associations within the framework are permitted by rules (Attribute Relationships) that may be established for each association between Network Component/Type combinations. Taken together, the Network Components and their associations or Behaviors and Types, all form the Framework Database.

3r. Replication of The Framework Database

The framework can and should be reproduced and distributed throughout a Network enterprise. Because the framework contains all of the information that describes a Network's (or a contiguous portion of a Network's) structure, the information contained in the framework is fundamental to many Network processes. The framework can be used to achieve consistency of the Network's structural information that is recognized and used by all business units within a Network enterprise. Because the framework is simple (e.g., typically fewer than 50 tables) and is built using commercial database features, capabilities, and standards, the distribution of information from one physical framework to another can be accomplished using the database vendor's standard tools provided for this purpose.

Commercial database providers (such as ORACLE, manufactured by Oracle Corporation of Redwood Shores, Calif., and SYBASE, manufactured by Sybase, Inc., of Emeryville, Calif.) provide “replication servers” that act on instructions developed for each specific replication task The nature and complexity of these instructions vary with the particular application. However, the distribution of the framework information between physical instantiations of the framework can be accomplished without the use of custom software or features specific to any vendor's database. This means that any replication scheme can be accomplished within the limitations of the database vendor's replication server's capabilities. FIG. # depicts a series of replications where an individual change to the information in one Framework Database can be propagated through all Framework Databases in the chain.

Replication can be used to Aggregate information from many smaller Framework Databases into a larger Framework Database. Thus, the framework structures can be organized into small, manageable domains that are designed to feed a much larger Framework Database. It is important to note that by using a common database and information structure, all, or part, of the Framework Database's information can be propagated throughout a Network enterprise and can be used to place every group, process, and/or task within a Network operation on a common foundation of understanding the Network's structure.

3s. Build Intrinsic Information for Replication of the Framework Database

The framework can be expanded to include Intrinsic Attributes that describe almost any aspect of a Network Component's character and/or Behavior. Such information is stored in a set of database tables or attribute tables that are associated with each of the six classes of Network Components, see FIGS. 12 and 1h. Each such Attribute table can be associated with one and only one Network Component class, but may be associated with the Types with that class. Each Network Component can be associated with one or more tables in its class through a “view,” where a view is simply an exclusive “joining” of one or more tables, where every “view” must contain the class's base table, plus all other tables required to make up a full compliment of Attributes. Note, an exclusive join is the combining of two tables where records that do not have entries in every table, within the join, are preferably discarded. FIG. 1h depicts a number of tables that might each contain different Attributes, or descriptors, that could be used to fully describe a Network Component. Clearly, each Network Component will not require all of the Attributes contained in the entire set of Attribute tables associated with its Component class. In fact, a Network Component may require only one Attribute table to fully describe its characteristics. There can be as many Attribute tables in a Component set as is required. It is suggested that the construction of new Attribute tables be limited to only those required to fully describe each Network Component Type with the minimum number of tables, where every Attribute in every table referenced by a Component Type is considered useful.

The framework does not permit the forming of associations between any entry (i.e., record) in any Attribute table and any other framework table other than the base table associated with that Attribute table.

Each Type within a Network Component class can be associated with a “view” (i.e., a subset of tables within a “cloud”). The Attributes contained in each Attribute table may be Type, feature, or application specific. This means that the Attribute tables for each Network Component class in each Framework Database can be tailored to the specific requirements of any system or process within a Network that has access to a specific database instance. The Attribute tables associated with each instance of the distributed framework databases within a Network's system environment can differ from instance to instance. However, all instances can use the same consistent set of information.

3t Attribute Sharing Between Attribute Tables

Attributes within Attribute tables can be shared to reduce the number of Behavioral tables. Typically, an internal structure used to link a particular Network Component with its Attributes. Every Network Component must be associated with a specific view defined in the view table associated with the class. Finally, every specific view may be associated with one or more tables contained within the set of Attribute tables associated with that class. Every Attribute table must contain a keyed Attribute that points to a particular ID that is contained in the base table for its class. Graphically, the existence of one or more sets of Attribute tables is depicted as an extension to the, or a replicated framework database. Using this structure, the framework permits as many Attribute tables, views, and Types as are needed to fully describe any set or class of Network Components.

3u. Task-Specific Replication

Each of the replicated framework databases can be associated with a different combination of one or more sets of Attribute tables. For example, a specific Framework Database might be expanded to support service provisioning, whereas another identical (because of replication) Framework Database might be expanded to support asset management. Still another might be expanded to support the engineering/construction efforts of a Network operation. All databases can be constantly updated so that every function-service provisioning, asset management, and engineering/construction-within the Network is supported by a consistent view of the Network's structure.

The Attribute tables can also be replicated and combined with other similar framework databases to form an aggregate database that contains a larger “view” of the Network. The reverse is also possible. A master database can be distributed to many smaller databases where each of the smaller databases contains only a portion of the master database information. The framework structure makes this kind of replication/distribution much easier (i.e., possible) to accomplish. Also, hybrid replication schemas can also be developed that include these Attribute tables.

3v. Data Management In/Out of Framework Databases

Layers of interactive software applications and servers, separate from the Framework Database(s), access the information in the Framework Databases that all communicate with the Framework Database(s) through a series of compatible computer languages and translation.

3w. Access Control & Application Specific Views

A layer of Access Control Servers and application specific views of the database set will preferably be the front-end of the Framework Database. These views will preferably cross the Framework Database's boundaries, and will be possible to execute multiple instantiations of the Access Layer Server. This layer of server software will manage security, database access (especially writing to a database) rules, and data location services and the like.

3x. Constraint Manager

A constraint manager will preferably be used to verify that all information “inbound” to a that database meets the acceptance criteria established for each Network operation's data traffic. The Constraint Manager will be based on a library of fast algorithms designed specifically for each Type of constraint. The Constraint Manager will also be accessible to the Network administrators, who will be able to add, modify, and/or delete constraints

3y. Rules Engine

A rules engine will be available to perform complex business logic that cannot be expressed as a series or set of constraints. The rules engine will also be accessible to the Network administrators, who will be able to add, modify, and/or delete rules.

3t. Application Programming Interface

A very granular and comprehensive API (Application Programming Interface-based on a computer language such as JAVA, CLC++, Python, or the like) will be available through which an external application can access any of the information and services available within the Framework Database(s). All user interfaces can access information and services through the API.

3z. Application Specific API's

Application specific Application Programming Interfaces (API's) can be added to augment the low-level APIs. Higher-level APIs provide applications with greatly simplified access to macro-services designed specifically for each application.

3.za. Integrating the Framework Database with Other Systems

Once a plan is in place for ensuring data integrity, there are several integration techniques that can be used to extend the Framework Databases support to the Network operation's other systems. The first technique is to replace existing legacy applications with applications designed to use the audited and consistent information and services provided by the Framework Database. However, this kind of integration is expensive and time consuming.

Another technique, similar to the first, is to modify an existing application to use the information and services offered by the Framework Database. This technique works well whenever a Network operation has access to the application's source code and has the in-house expertise to modify it.

Service adaptation can be employed to cause the Framework Database to appear to an existing application as the application's own database. This is done through a combination of view building and API sequence logic. When this technique is implemented well, it is the most successful, cost effective, and best performing integration technique.

A variant on the previous technique is to replace only a portion of the existing application's database with services provided by the Framework Database. Once again, service adaptation is used to present the application with a view into the Framework Database that looks like the application's own database.

Finally, a third integration alternative is to execute an audit process that continuously compares related or common information from an external source to the corresponding information in the Framework Database. If an inconsistency is found, the Data Auditing System (DAS) will either correct the problem (this is usually only possible for simple kinds of comparisons and inconsistencies), or it will “notify” operations personnel that an inconsistency exists and provide them with enough information to identify and re-locate the inconsistency, and take remedial action.

It should be noted that no large integration effort will rely on a single integration technique. All methods may be employed independently and/or collectively to achieve data integrity across a Network enterprise.

4. Description of Various Embodiments

4a Service Delivery Networks “SDN”

SDNs provide a method for integrating, restructuring, and storing in a database, a single data structure describing a large set of independent and hierarchical data structures. They are created to track how Networks are divided during the replication of Framework Databases. They are recognized by the Framework Database as Types, represent groups of Network Components that have a Group character or Behavior, and may be contained within any Network Strata of a Framework Database. SDNs include all sorts of networking services and schemas (even hybrids), including WDM, SONET, NADH, EDH, PDH, frame relay, ATM, IP, voice, cellular/mobile, voice/IP, and any convergent combination, configuration, or sub-division thereof. Each SDN is associated with a set of Service Inter-Working Capabilities, and provides at least one kind of Service-Segment.

All SDNs are designed to provide one or more service capabilities. Therefore, the purpose of each SDN described in the framework is to track the Component structure of each SDN's consumables. Within the rules governing SDN building in the framework, which are described in detail below, the creation of SDNs is arbitrary and may be organized in any fashion. However, there are several issues regarding the nature of SDN building. Usually the number of different service capabilities defined for each SDN should be minimized. In the standard, circuit-based, layered Networks common to most carriers, this is easily accomplished. Every physical Network should be decomposed into SDNs that each offer the minimum number of possible service classes, where each such SDN cannot be further decomposed without creating two or more SDNs that compete for the same resources.

4b. Building SDNs

An SDN is a pattern that is made up of a collection of connected SDN components. The SDN Components include Access Terminators, Access Spans, Intra-Networking Spans, Core Terminators, SDN-Sets, and Service-Segments. All SDNs conform to the definition of an Entity and to the definition of a Communications Network Component.

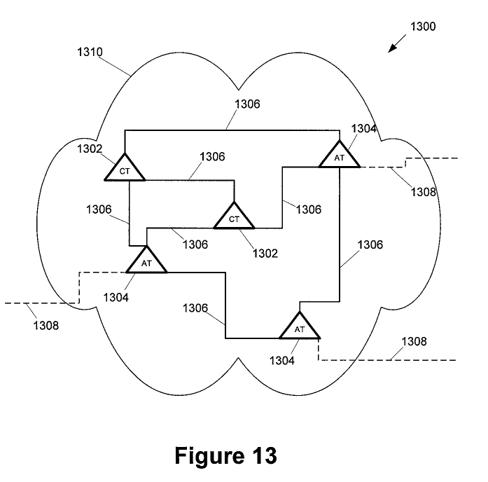

FIG. 13 depicts an accurate illustration of an SDN's structure and functions. Each Terminator and each Span within an SDN must be assigned a role. There are two possible roles each, for both Terminators and Spans. These are: an access role (i e, Access Span, or “ASP”) refers to a Span that connects to at least one Terminator outside of the Network and at least one Terminator inside an SDN; and an Intra-Networking role (i.e., Intra-Network Span, or INS) refers to a Span that connects only to Terminators that are within an SDN. All Network Terminators may participate in Containment Relationships that describe the Aggregation of two or more Network Terminators that can each connect directly to the Network's ASPs and/or INSs. In this case, aggregated SDN Terminators (e.g., higher level logical sub-components) may or may not support direct connection to the SDN's ASPs and/or INSs.

The simplest of all Network patterns consists of a single Access Terminator and no INSs. This configuration is called a Star Network. Any SDN where all of the Terminators and Spans form a single Loop is called a Ring Any SDN that has at least two Loops is called a Partially Meshed Network.

Finally, a Network that has at least two Geographically diverse INSs existing directly between every set of two Terminators within the SDN is called a Fully Meshed Network. All other Network patterns are hybrids of these patterns. SDNs are further subdivided into the following classes:

4c. SDN-Sets

An SDN-Set is an Aggregation of two or more SDNs where Identical or similar SDNs share one or more common ASPs, and at least one common service capability.

“Bridged” SDNs share one or more internal connections (i e, a bridge is a connection made inside a Terminator that may, or may not, include the capability to adapt one SDN technology to another), or any combination of the above two.

The ASPs of any SDN-set are defined as the union of all of the ASPs belonging to the SDNs making up the SDN-Set, exclusive of all ASPs held in common between any two of the SDNs. The ASPs held in common between the members of an SDN-set will be treated as INSs in the SDN-set.

The framework of the present invention permits many perturbations and permutations of SDN Aggregation. SDN-Set Aggregation is a useful method of combining similar, or identical, SDNs in order to manage each of the aggregated SDNs separately for some purposes and in aggregated form for other purposes.

4d. SDN Groups

An SDN Group refers to any Aggregation of two or more otherwise unrelated, and disconnected SDNs.

4e. Trunk Groups

A Trunk Group is an Aggregation of two or more INSs that all connect to the same set of Terminators. SDNs may be constructed from any appropriate set of Terminators and Spans taken from inventory.

4f. SDN Layering

SDNs may be Layered, one on top of another, in hierarchical fashion, as required to fully describe the actual SDN structures. The two issues to be considered in the layering process, from a database and logical point of view are the compatibility of each subordinate Layer with the Service-Segments provided by its superior Layers; and the quality of Service-Segments considerations to be managed between the layered SDNs.

4g. Communication Service Inter-Working Capability

Communication service inter-working capability refers is the ability of an SDN to translate one Communication Service Capability Stack to another Communication Service Capability Stack for all communication signals that pass through the SDN. There are two different types. The first is called Type 1 Communication Service Capability. This refers to any Communication Service Capability based on Permanent Circuits (whether Physical or Logical) where the SDN Route of each such circuit is fully described in the Framework Database's inventory. It is made up of two or more connected ASPs providing an identical service (e.g., Circuit based service, frame relay), and is a deterministically routed Network.

The second is called Type 2 Communication Service Capability. It refers to any Communication Service Capability based on Switched Circuits (whether Physical or Logical), connectionless routing methodologies, or permanent Circuits (whether Physical or Logical) where the SDN Route of each such circuit is not fully described in the Framework Database's inventory. It has only one ASP provided without respect to any other ASP. It is evaluated on predictability, and includes all switched and routed services that display traffic direction with a semblance of exactitude, where the loss of traffic is a measurement of quality.

4h. Managing Diversity within SDNs

Diversity between two or more SDNs should be tracked. For example, in order to protect against a circuit failure due to a fiber cut, two Redundant Circuits might traverse different geographical routes. Or, in order to protect a Redundant Circuit against the failure of a supporting Network Element, its Component Circuits might be routed through completely different Network Elements.

Diversity must always be measured with respect to the use of certain Network facilities (i.e., Network Components, SDNs, or any portion thereof) or facility types. For the purpose of measuring Diversity, two methods (or any combination thereof) are provided. The first method is to specify lists of facilities that are referenced by name for Diversity calculations. Each such list describes a Diversity Domain In the Framework Database, a Diversity Domain will include any combination of Network Components.

The second method is to specify a list of Types of facilities that can be used to generate a Diversity Domain when performing Diversity calculations between two Network Components or SDNs. Such a list of facility Types is called a Type Domain. The framework database supports both circuit-to-circuit and circuit-to-facility Diversity calculations. Specifically, the following capabilities are supported:

Diversity Domains: Any number of Diversity Domains may be created, edited, and deleted. Any Network Component may be added to, or deleted from, a Diversity Domain.

Type Domains: Any number of Type Domains may be created, edited, and deleted. Any specific Network Component Type may be added to, or deleted from, a Type Domain.

Diversity calculations: Any Circuit may be checked for Diversity with respect to any Diversity Domain. Any two or more Circuits may be checked for Diversity with respect to any Type Domain.

Diversity groups: Any Aggregation of Circuits. Diversity groups are used to determine whether two groups of Circuits use the same Network Aggregations.

Diversity Attributes: Each Circuit constructed in the Framework Database may be described as having Diversity requirements with respect to any number of other Circuits, Diversity Domains, Type domains, or combination of the foregoing.

Diverse routing: When a new Circuit with a requirement, or set of requirements, for Diversity is constructed, the available facilities for routing that Circuit will be limited to those facilities that meet its Diversity requirements. In the event that a Circuit with Diversity requirements must be re-routed, only those facilities meeting the Circuit's Diversity requirements will be available for the re-route (i e, grooming) activity. This capability applies only to those SDNs managed by the Framework Database.

4i. Managing Resource Utilization within SDNs and other Internal and External Networks

One of the most difficult tasks associated with operating an expanding SDN is the optimization of the Network configuration to reduce overall costs and to improve quality and reliability. This task is referred to as “grooming” the Network.

Grooming activities can be divided into three tasks: identifying grooming opportunities; determining an appropriate target configuration; and implementing the Network reconfiguration.

Performance of these tasks may require either deterministic or heuristic methodologies, or both. For the most part external Networks can be groomed using deterministic techniques, whereas the calculation of grooming opportunities for internal Networks will rely more on heuristic methods, usually requiring historical performance statistics. The framework will employ only deterministic methods to identify grooming opportunities. Such identification is performed: whenever a new service request is fulfilled by the framework; whenever a request for a grooming calculation with respect to a specific Network is made, or portion of a Network; and/or on a low-impact, continuous basis.

4j. Managing Service Routing in SDNs to Recognize Grooming Opportunities

Every SDN in the framework should have an associated set of routing Attributes. Routing Attributes may express any aspect of SDN measurement. For example, a routing Attribute for a Circuit might express the number of Physical Ports traversed by the Circuit. Another such Attribute might express the length of the Circuit in miles (or kilometers). Because grooming is usually associated with improving the cost efficiency or performance of a Network, such routing Attributes can be used as input to simple rules for identifying potential grooming opportunities. For example, a grooming opportunity might be identified by the existence of available lower-cost capacity between the same two points traversed by an SDN's INSs.

Pattern recognition can also be used to identify grooming opportunities. Computer processes within the Framework Database will search for certain predefined patterns within an SDN to identify grooming opportunities.

4k. Networking Examples of how the Framework is used to Describe any SDN

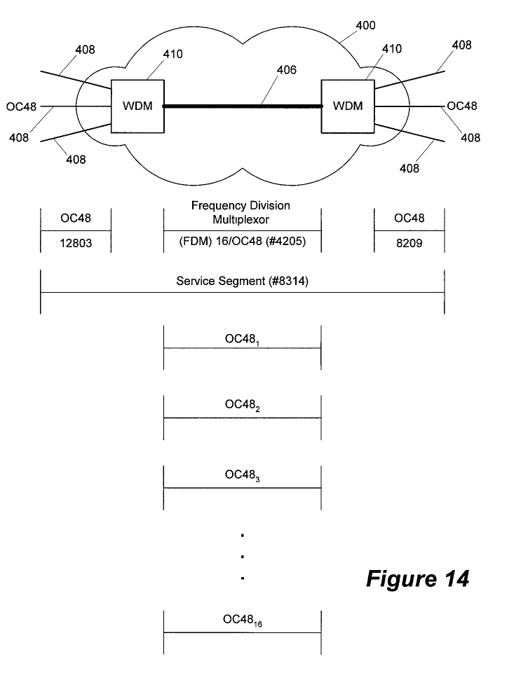

A set of connected WDM (a type of network) multiplexers may be described as an SDN having ATs and CTs that correspond to each of the WDM multiplexers and amplifiers, if the Graph formed by the WDM equipment and cables forms a connected Connectivity Graph, see FIG. 14. The frequency multiplexed optical Circuits between WDM multiplexers act as the SDN's INSs. The OC48 access circuits act as ASPs. The service capability of the WDM Network is limited to optical (OC48) transmission between sets of OC48 ASPs. The consumables of such an SDN correspond to its configured Service-Segments, since there is a one-to-one correspondence between the ASPs, Access and Core Terminator;, INSs, and the SDN's service-segments. In certain cases, multiple WDM Network elements, all at the same Location, may be aggregated to form a Logical element that can be treated as a single Terminator with regard to the SDN's structure.

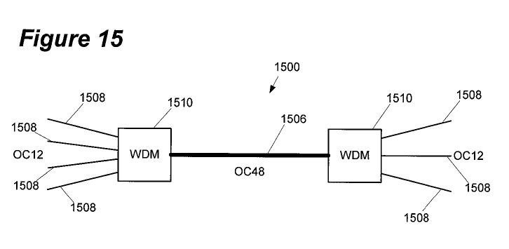

A SONET Network may be described as an SDN having ATs and CTs that correspond to the SONET entities; and having INSs that correspond to the OC48 Circuits, or to other appropriate bandwidths, see FIG. 15. The SONET SDNs OC12 and OC3 access Circuits correspond to ASPs, regardless of their configuration. The service capability of the SONET Network is limited to two optical transmission Service capabilities between sets of OC12 and OC3 ASPs The consumables of such an SDN are the OC3 and OC12 ASPs, the bandwidth capacity of each SONET entity, and the OC48 INSs. Once again, in some cases, multiple SONET entities existing at a single location may be aggregated into logical Terminators to fit the SDN model.

An IP Network may be described as a SDN having IP routers that correspond to the ATs and CTs; and having OC3 or OC12 trunks connecting the routers that correspond to the INSs, see FIG. 13. The various access Circuits (usually DSI through OC3) correspond to the ASPs. The Service capability of the IP SDN might include both Isochronous and Asynchronous Service-Segments between sets of ASPs, or it might include Service-Segments that involve only one ASP, all depending on the carrier's intended use of the Network. The consumables of such an SDN are its ASPs, the bandwidth capacity of each router, and the INSs.

5. Example Applications of the Method

Telecommunication Network Configuration Data represents one of the most complicated data management problems that exist today and one of the most productive areas for applying the method of the present invention.

FIGS. 3a through 3g illustrate the building blocks for the method and apparatus of the present invention. FIG. 3a shows a single node 12. FIG. 3b illustrates a set of Entities 12. FIG. 3c shows a Behavior 14 FIG. 3d shows a Behavior 14 establishing a Relationship between two Entities 12. FIG. 3e shows a more complex Relationship having two Behaviors 14 that identify a Relationship between two sets of Entities 12, respectively. FIG. 3f illustrates a set of Network Entities 16 such as those shown in FIG. 3e. FIG. 3g shows a simple Graph 18 of the present invention. The graph 18 can illustrate either a Connectivity Graph or a Hierarchical (tree) Graph.

The direction from the first Entity toward the one or more second Entities shall be called the forward or downward direction that moves from the postal end toward the distal end. The direction from the one or more second Entities toward the first Entity shall be referred to as the reverse or upward direction meaning from the distal end toward the postal end. Further, each direction within the Hierarchical Relationship must be defined in terms of the Logical inverse of the other direction. Unless otherwise defined, a single Entity can have one and only one reverse Hierarchical Relationship of the same Relationship class. The upward and downward directions mentioned above are merely illustrative of an embodiment of the present invention. Alternate embodiments of the present invention, the directions of the postal and distal relationships can be reoriented in any manner.

More complex Hierarchies can be formed by combining the Graphs depicting one or more simple Hierarchies wherein the first entity of one simple Hierarchy also belongs to the one or more second Entities of another simple Hierarchy, where the Hierarchical Relationships of both simple Hierarchies are of the same class Thus, all Hierarchies have an implied layered structure relative to the Graph formed by all members of the Hierarchy.

For example, if a first Entity has a forward Hierarchical Relationship (of class X) to one or more second Entities, and any one of the Entities within the second Layer has the same Type of forward Hierarchical Relationship (i.e., of class X) with one or more third Entities, three Layers are formed. Hierarchies are depicted by tree Graphs.

FIG. 3h shows a Hierarchical Graph 18h containing a set of Entities 12 in a hierarchical (inverted tree) relationship. The first Entity 12 (designated “B”) is at the topmost postal position. All of the Entities 12 to which the “B” Entity 12 is connected to lie in a downward or distal direction from the “B” Entity. In FIG. 3h, the first set of distal Entities are designated “B11,” “B12,” and “B13.” In the example illustrated in FIG. 3h, the “B13” Entity 12 itself has a related Behavior 14 h with four Entities 12 designated “B131,” “B132,” “B133,” and “B134.” Finally, the “B133” Entity 12 itself has a related Behavior 14h with four additional Entities 12 designated “B1331,” “B1332,” “B1333,” and “B1334.”

FIG. 4a shows a Connectivity Graph 18c containing a set of Entities 12 that are joined by Behaviors 14 to form a simple Network configuration. FIG. 4b shows a side view of the Connectivity Graph 18cof FIG. 4a. When the Connectivity Graph 18c, such as the one in FIG. 4a, is rotated flat, it is termed a Layer 20 as shown in FIG. 4b.

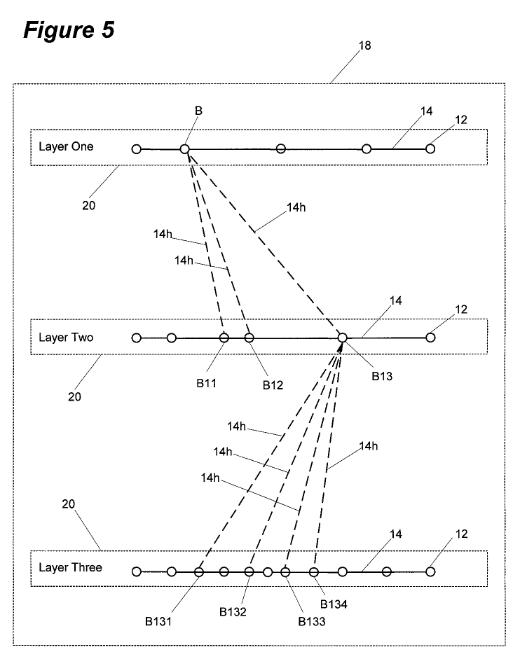

FIG. 5 shows a series of three Layers 20, each having Entities 12 and Behaviors 14. As shown in FIG. 3, a single Entity 12 is designated as “B” in Layer One, which is in a postal (higher) relationship to Layer Two 20 and Layer Three 20. The “B” Entity 12 has related Behaviors 14h with three Entities 12 designated “B11,” “B12,” and “B13” within Layer Two. Similarly, the Entity 12 labeled “B13” has related Behaviors 14h with four Entities 12 designated “B131,” “B132,” “B133,” and “B134” in Layer Three.

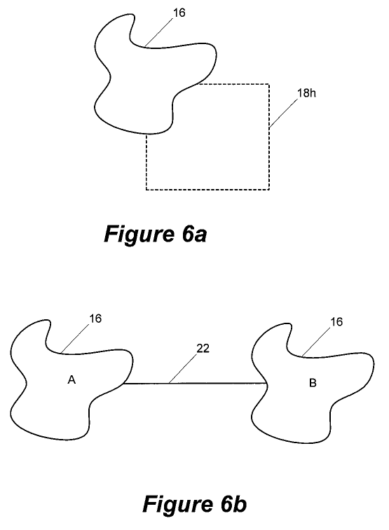

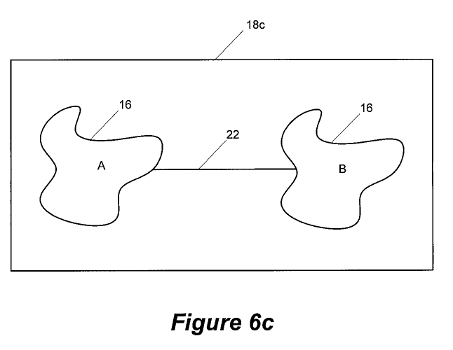

FIG. 6a shows a set of Network entities 16. A set of zero or more Hierarchical Graphs 18h can be related to the set of Network Entities 16 as shown in FIG. 6a. Some of the Entities within the set of Network Entities 16 can be identified as Relationships that can be included in the Hierarchical Graph 18h of FIG. 6a. FIG. 6b shows two sets of Network Entities 16 (designated “A” and “B”) wherein one or more Entities of set A may have a Connectivity Behavior 22 with one or more Entities of set B. FIG. 6c illustrates the Network Entity sets 16 of FIG. 6b wherein one or more Entities of set A has a connectivity Behavior 22 with one or more Entities of set B to form a Connectivity Graph 18c.

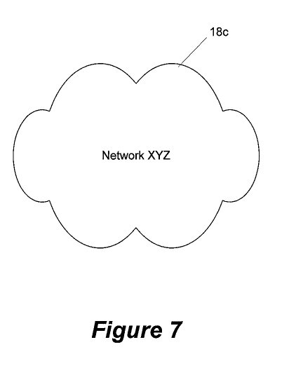

FIGS. 7 through 12 set forth an example application of an alternate embodiment of the present invention for classifying a general set of Network configuration data into a set of interrelated Graphs to form a 6×2 chart. This particular example is directed toward a telecommunications application. However, other types of Networks can be modeled using the method of the present invention.

The example begins with the illustration in FIG. 7, where the Network configuration data for a specific Network (i e., network “XYZ”) has been collected but no Graphical Elements have been identified. FIG. 7 shows a generic unorganized set of Network information 24 designated Network “XYZ.”

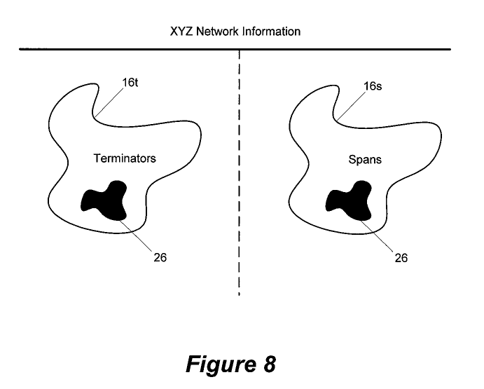

FIG. 8 shows a set of Terminators 16t and a set of Spans 16s that comprise part of the Network information 24 of FIG. 7. FIG. 8 illustrates part of the method of the present invention where the various Network Elements (Terminators and Spans) are identified and classified. Note in FIG. 8 that there may be duplicate elements 26 within both sets 16t and 16s. The duplicate elements 26 must eventually be uniquely classified as either a Terminator or a Span according to the method of this alternate embodiment of the present invention.

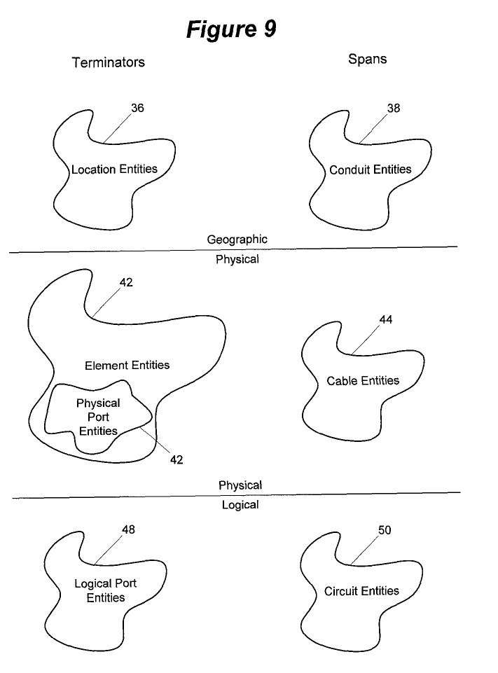

The next step in the example is to identify all of the connectivity Behaviors and to form the Layers. In order to help the identification effort, the set of Terminators 16 t and set of Spans 16 s are further classified into three sub-classes of Layers (the Geographic, the Physical, and the Logical Layer sub-classes), as shown in FIG. 9. The geographic Layers consist of Location Entities and conduits Entities. The physical Layers consist of Network element Entities and Cable Entities. The logical Layers consist of Logical Port Entities and Circuit Entities. Each of the three sub-classes of layers has both Terminators (36, 42, 48) and Spans (38, 44, 50). Further, each sub-class contains a set of Terminator Entities and a set of Span Entities, as indicated. Alternatively, the Network Elements are further classified into finer sets 36, 38, 42, 44, 48, and 50. Within each Network element sets can be additional subsets such as the Physical Port Entities 16 within set 42.

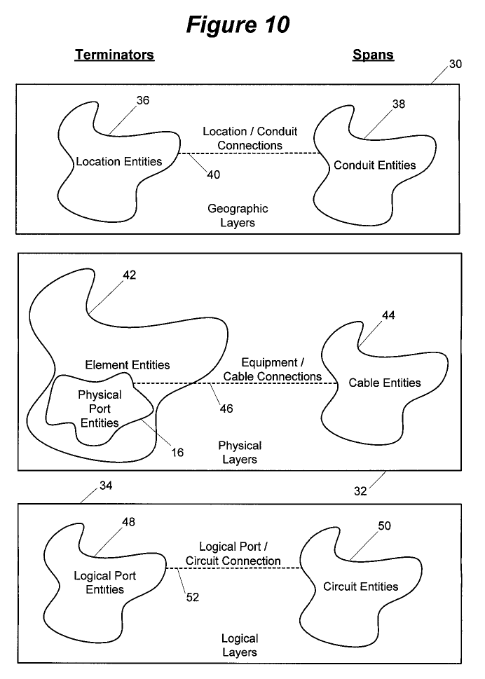

FIG. 10 illustrates the element sets of FIG. 9 arranged into three Layers 30, 32, and 34. Behaviors (40, 46, 52) connect the Terminators (36, 42, 48) to the Spans (38, 44, 50), respectively within the respective Layers. As shown in FIG. 10, all connectivity Behaviors are then identified and a set of interrelated Connectivity Graphs (Layers) are formed. Terminator entities in each class may have Connectivity Behaviors with individual Span entities, and only Span Entities, belonging to the same Layer. Such Connectivity Relationships may, or may not, be governed by other class and entity specific Connectivity rules defined above.

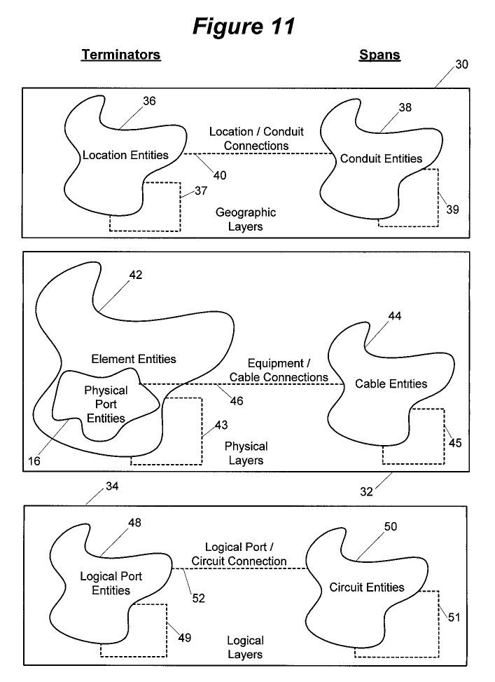

FIG. 11 has the elements of FIG. 10 with the addition of Hierarchical Graphs 37, 39, 43, 45, 49, and 51. In FIG. 11, all of the Hierarchical Relationships between the Terminators within each Layer sub-class, and all Spans within each Layer sub-class, are identified.

FIG. 12 has all the elements contained within FIG. 11 with the Hierarchical Behaviors 52, 54, 56, and 58 established among the various Entity sets 36, 38, 42, 44, 48, and 50. Here, all of the Hierarchical Relationships between Terminators belonging to different Layer subclasses, and between Spans belonging to different Layer sub-classes, are identified and depicted. Specifically, behavior 52 is the location/equipment containment behavior between the location entities 36 and the element entities 42. Behavior 54 is the conduit/cable containment behavior between the conduit entities 38 and the cable entities 44. Behavior 56 is the physical port/logical port containment behavior between the element entities 42 and the logical port entities 48. Behavior 58 is the cable/circuit containment behavior between the cable entities 44 and the circuit entities 50. FIG. 12 is illustrative of a complete set of Network configuration information expressed in a set of interrelated Graphs. The 6×2 structure (6 element sets in two columns) is clear. The resulting Network model can be used reliably and extensively by numbers segments of the user organization.

It is desirable for the Network configuration information illustrated in FIG. 12 to be displayed to a user and is within the scope and spirit of the present invention. Moreover, computer software applications can be written to facilitate the identification, classification and position of the various Network Entities to develop a Network configuration information similar to the one illustrated in FIG. 10. The preferred embodiment of the present invention includes computer software working on a suitable computer system that enables a user to identify, to categorize, to classify, to load, to store, to query, and to display any or all of the Network Entities that comprise the complete Network configuration information.

Attention is directed to FIG. 15, which illustrates a pattern that is illustratively called a Service Delivery Network (SDN). An SDN 1500 has one or more Core Terminals 1502 and one or more Access Terminals 1504 that are connected to each other by Intra-Networking Spans 1506. The main difference between the Core Terminal 302 and the Access Terminal 304 is that the Core Terminal 1502 does not have direct access outside the SDN 1500. Access Spans (ASP) 1508 are used to connect the outside world to the SDN 1500, specifically to the Access Terminals 1504 as illustrated in FIG. 15. The Service-Segment will have a structure designated something like <ASP, INS, ASP>. All Service-Segments are Concatenated Circuits. The SDN 1500 itself is has an SDN Boundary 1510 that contains all of the elements of the SDN.

There are two types of Service-Segments that are available to Customers: Type 1 and Type 2. A Type 1 Service Segment has two or more ASPs 1508, typically with identical service on each end that may be permanent. The loads under a Type 1 Service Segment are typically known exactly. Type 2 Service Segments involve only one ASP 1508. Normally, the Type 2 Service Segment is for contingency services and the load is usually estimated statistically.

The present invention, therefore, is well adapted to carry out the objects and attain both the ends and the advantages mentioned, as well as other benefits inherent therein. While the present invention has been depicted, described, and is defined by reference to particular embodiments of the invention, such references do not imply a limitation on the invention, and no such limitation is to be inferred. The invention is capable of considerable modification, alternation, alteration, and equivalents in form and/or function, as will occur to those of ordinary skill in the pertinent arts. The depicted and described embodiments of the invention are exemplary only, and are not exhaustive of the scope of the invention. Consequently, the invention is intended to be limited only by the spirit and scope of the appended claims, giving full cognizance to equivalents in all respects,

What is claimed is:

1. A method for modeling a telecommunications network in a computer system having a database, said method comprising the steps of.
identifying entities of said network, each of said entities having at least one identifying attribute;
assigning a unique value to said identifying attribute to each of said entities; and
organizing said entities into at least one data table in said database to create a model for said network;
wherein said computer system model is enabled to determine characteristics of said network by using said database.

2. A method as in claim 1, said method further comprising the step of typing said entities.

3. A computer system, said computer system supporting a model of a set of data representing entities and behavior, said data comprising:
a plurality of said entities; each of said entities having at least one entity attribute, said entities grouped into a set of entity charts, wherein a first entity chart contains only one or more entity attributes that are shared by all of said entities, and a second set of entity charts containing the balance of said entity attributes; and
at least one of said behavior, said behavior having at least one behavioral attribute, said behavior further referencing at least two of said entities, said at least one behavior grouped into a set of behavior charts, wherein a first behavior chart contains only one or more behavior attributes that are shared by all of said behavior, and a second set of behavior charts containing the balance of said behavior attributes;
wherein said first entity chart and said first behavior chart form a subset of said data that describes one or more structural relationships among said entities.

4. A computer system as in claim 3, wherein all of said charts describe all characteristics of said network.

5. A computer system, said computer system supporting a model of a set of data representing entities and behavior, said data comprising:
a plurality of said entities; each of said entities having at least one entity attribute, said entities grouped into a set of entity charts, wherein a first entity chart contains only one or more entity attributes that are shared by all of said entities, and a second set of entity charts containing the balance of said entity attributes; and
at least one of said behavior, said behavior having at least one behavioral attribute, said behavior further referencing at least two of said entities, said at least one behavior grouped into a set of behavior charts, wherein a first behavior chart contains only one or more behavior attributes that are shared by all of said behavior, and a second set of behavior charts containing the balance of said behavior attributes;
wherein said first entity chart and said first behavior chart may be replicated without compromising the integrity of said data on said charts.

6. A computer system as in claim 5, wherein said are represented by tables in a database.

7. A computer system as in claim 6, wherein said first entity chart is represented by a first entity table in said database.

8. A computer system as in claim 7, wherein said first behavior chart is represented by a first behavior table in a database.

9. A computer system as in claim 8, wherein said first entity table and said first behavior table are aggregated within a first subdatabase.

10. A computer system as in claim 9, wherein said first subdatabase can be replicated in a fully redundant manner.

11. A computer system as in claim 9, wherein said first subdatabase can be replicated in a hierarchical manner.

12. A computer system as in claim 9, wherein said first subdatabase can be replicated in a hybrid manner.

13. A computer system, said computer system supporting a model of a set of data representing entities and behavior, said data comprising:
a plurality of said entities; each of said entities having at least one entity attribute, said entities grouped into a set of entity charts, wherein a first entity chart contains only one or more entity attributes that are shared by all of said entities, and a second set of entity charts containing the balance of said entity attributes; and
at least one of said behavior, said behavior having at least one behavioral attribute, said behavior further referencing at least two of said entities, said at least one behavior grouped into a set of behavior charts, wherein a first behavior chart contains only one or more behavior attributes that are shared by all of said behavior, and a second set of behavior charts containing the balance of said behavior attributes;
wherein said first entity chart and said first behavior chart enable the implementation of a service delivery network.

14. A method for organizing a set a data, said method comprising the steps of:
separating proto-entity data from proto-behavior data, wherein said proto-behavior data is limited to a subset of said data that describes behavior pertaining only to those proto-entities that are members of said data set;
separating said proto-entity data into entity subsets, each of said entity subsets contain all entity-attributes pertaining to one instance of said proto-entity such that the number of said entity subsets is equivalent to the number of said proto-entities;
forming an identifying subset of entity-attributes for each of said proto-entities, such that said identifying subset of entity-attributes uniquely identifies said proto-entity to which said subset of entity-attributes pertain to form a set of unique entities;
separating said proto-behavior data into behavior subsets, each of said proto-behavior subsets contain all behavior-attributes pertaining to one instance of said proto-behavior, such that the number of said behavior subsets is equivalent to the number of said proto-behavior instances;
forming an identifying subset of behavior-attributes for each of said proto-behavior, such that said identifying subset of behavior-attributes uniquely identifies said proto-behavior to which said subset of behavior-attributes pertain to form a set of unique behavior;
forming a set of entity charts where each of said entities are represented by a single entity chart;
forming a set of behavior charts where each behavior is represented by a single behavior chart;
copying from said entity charts said identifying subset of said entity-attributes in each of said entity charts to form an entity base chart; and
copying from said behavior charts said identifying subset of behavior-attributes in each of said behavior charts to from a behavior base chart;
wherein said base charts can be replicated independently of other said entity charts and other said behavior charts without compromising the integrity of said charts.

15. A method for generating a database of information on a computer system about a network, said method comprising the steps of:
providing a set of data concerning said network;
identifying attributes that pertain to entities as an entity attribute to form a set of entity attributes;
identifying attributes that pertain to behaviors between two entities as a behavior attribute to form a set of behavioral attributes;
organizing said entity attributes into a group of proto-entities and a group of entities;
organizing said behavior attributes into a group of proto-behaviors and a group of behaviors;
adding unique identifiers to each of said proto-entities to form additional entities;
adding unique identifiers to each of said proto-behaviors to form additional behaviors;
separating each of said entities into either a structure group or an entity warehouse, said entities separated into said structure group having a minimum set of attributes that are required to establish the uniqueness of those entities, said entity warehouse having all said entities that are not within said structure group; and
separating each of said behaviors into either said structure group or a behavior warehouse, said behaviors separated into said structure group having the minimum set of attributes that are required to establish the uniqueness of those behaviors, said behavior warehouse having all behaviors that are not within said structure group;
wherein said structure group can be replicated independently from said warehouse.

16. The method according to claim 15 wherein after said step of adding unique identifiers to each of said proto-entities to form additional entities creates a set of entities, each of said entities being uniquely identified.

17. The method according to claim 15 wherein after said step of adding unique identifiers to each of said proto-behaviors to form additional behaviors creates a set of behaviors, each of said behaviors being uniquely identified.

18. The method according to claim 15 wherein after said step of adding unique identifiers to each of said proto-behaviors to form additional behaviors creates a closed set of behaviors, each of said behaviors being uniquely identified and identifying only entities that are within said set of entities.

19. The method according to claim 15, wherein said entity warehouse is divided into two or more portions.

20. The method according to claim 19, wherein said behavior warehouse is divided into two or more portions.

21. The method according to claim 20, wherein said structure group is constructed and arranged to operate with any portion of said entity warehouse and said behavior warehouse.

22. A method for generating database table structures for a computer system, said method comprising the steps of:
(a) providing a set of original information about a network;
(b) transforming at least a portion of said original information into subsets of Entities, Proto-Entities, Behaviors and Behaviors;
(c) identifying uniquely the Proto-Entities and Proto-Behaviors;
(d) identifying the structural Attributes for each Entity and each Behavior;
(e) forming Charts from said Attributes identified in said step (d); and
(f) mapping said Charts into database tables;
wherein said database tables can be loaded with information about said Entities and said Behaviors in order to construct a model of said network.
